(19) United States
(12) Patent Application Publication
(10) Pub. No.: US 2026/0368995 A1
(43) Pub. Date: Nov. 19, 2026

(54) CONSTRUCTING A LEVEL OF DETAIL HIERARCHY FOR 3D GAUSSIANS

(71) Applicant: NCMesh s.r.o., Prague (CZ)

(72) Inventor: Jakub Cerveny, Prague (CZ)

(21) Appl. No.: 19/657,913

(22) Filed: Apr. 24, 2026

Related U.S. Application Data
(60) Provisional application No. 63/804,743, filed on May 13, 2025.

(51) Int. Cl. G06T 15/08; H04N 19/96

(52) U.S. Cl. CPC G06T 15/08; H04N 19/96

(57) ABSTRACT

Systems and methods are provided for constructing a level-of-detail (LOD) hierarchy for 3D Gaussian representations. The LOD hierarchy can be referred to as “an LOD tree”. The systems and methods can be used, for example, to generate a continuous, streaming-compatible LOD hierarchy from an arbitrary finished 3D Gaussian set. Methods can include performing offline, data-driven simplification (merging/clustering) of 3D Gaussians from, and derived from, the arbitrary finished 3D Gaussian set while recording explicit parent/child lineage. At runtime, a renderer can select resolution per region, for example, and progressively refine as finer data streams in without retraining, and without access to, training images.

### CROSS-REFERENCE TO RELATED APPLICATIONS

This application claims priority to U.S. Provisional Application No. 63/804,743, filed May 13, 2025, which is hereby incorporated by reference herein in it's entirety.

### BACKGROUND

### Field of the Invention

The systems and methods taught herein are generally directed to level-of-detail hierarchies for 3D Gaussians used in rendering images.

### Description of the Related Art

Recent advances in radiance field rendering have introduced the 3D Gaussian Splatting (3DGS) method, which enables photorealistic novel view synthesis of real-world scenes. This technique represents a scene as a collection of 3D Gaussians, each defined by attributes such as position, covariance (scale and orientation), color, and opacity. During rendering, these Gaussians are splatted and composited to produce high-fidelity images from arbitrary viewpoints. Compared to traditional mesh- or voxel-based representations, 3DGS allows for smooth, high-quality rendering with a simple sparse data structure and fast convergence.

However, one significant challenge in deploying 3DGS representations in practical applications, such as games, virtual/augmented reality (XR), visual effects (VFX), architecture/engineering/construction (AEC), industrial spatial intelligence, and more, is the large number of Gaussians typically required to accurately represent complex scenes. This results in large data sizes that are costly to stream, especially to end-user devices with constrained bandwidth or memory. Moreover, rendering performance suffers in large-scale environments, limiting how these data structures can be used in real-time or interactive use cases.

To address these issues, Level of Detail (LOD) schemes are commonly employed in computer graphics to reduce rendering costs and bandwidth requirements by simplifying or coarsening geometry based on distance, screen size, or other viewing parameters. In the context of 3DGS, recent research has attempted to build LOD hierarchies, and these have required implementation during the training process itself. These approaches suffer in that they require access to the original scene data, such as calibrated image sets, and depend on high-end GPU resources to retrain or optimize each level of the hierarchy. Additionally, even when a hierarchical LOD structure is eventually generated, there is no standardized or efficient method for compressing, transmitting, or streaming the resulting data structure to downstream devices or applications.

Accordingly, there is a need for a method to generate an LOD hierarchy for 3D Gaussians that:
(i) does not require access to the original training data or retraining;
(ii) can be applied post hoc to existing 3DGS datasets;
(iii) produces an LOD hierarchy that is compact, streamable, and render-efficient;
(iv) supports scalable deployment in real-world streaming and rendering systems; and,
(v) provides a general-purpose solution for bandwidth-sensitive 3D rendering by organizing Gaussian datasets into a compact LOD tree suitable for streaming, storage, and real-time rendering.

### SUMMARY

Systems and methods for building LOD trees from 3D Gaussians are provided. The LOD trees include a set of source 3D Gaussians and a set of merged 3D Gaussians derived from the source set of 3D Gaussians during the building. In some embodiments, the method comprises obtaining the source set of 3D Gaussians, and building the LOD tree from the source set of 3D Gaussians and their progeny, each of the progeny being directly or indirectly linked one or more respective descendants, the linking providing a “resolution pathway” that configures the LOD tree to allow for a selection of 3D Gaussians that provide any of a variety of desired resolutions for the rendering of an image.

In some embodiments, the building of an LOD includes (i) creating a working set of 3D Gaussians that initially include the source of 3D Gaussians; (ii) merging, or “pairing”, sufficiently similar 3D Gaussians in the source set of 3D Gaussians to create merged 3D Gaussians; (iii) updating the working set to add the merged 3D Gaussians and remove the 3D Gaussians that were merged to create the 3D Gaussians; (iv) repeating the merging and the updating among all 3D Gaussians in the updated working set of 3D Gaussians and continuing the repeating and updating until there are no sufficiently similar 3D Gaussians for further merging; (v) linking all merged 3D Gaussians to a plurality of their respective descendant 3D Gaussians to build an LOD tree. It should be appreciated that the “similarity” can be determined by comparing 3D Gaussian attributes of a first 3D Gaussian and a neighboring 3D Gaussian, and if the similarity is sufficient, the first 3D Gaussian and the neighboring 3D Gaussian can be paired to create the merged 3D Gaussian. When the repeating and updating are complete in the LOD tree, one or more “root nodes” are the result and represent the coarsest level of resolution. The set of source 3D Gaussians represent the finest level of resolution. The linking between a root node and it's descendants provides a pathway through the tree for that respective root node that allows for a selection of a desired resolution when rendering an image from the LOD tree.

In some embodiments, the method comprises obtaining the source set of 3D Gaussians, and building the LOD tree, the building including storing 3D Gaussians in a database, where the term “database” can be used to refer to a traditional database or an in-memory database (IMDB), RAM, etc, in some embodiments, each of the 3D Gaussians including a set of attributes, the storing including indexing each 3D Gaussian in the source set of 3D Gaussians, and each 3D Gaussian in the set of merged 3D Gaussians derived from the source set of 3D Gaussians during the building, the indexing configured to provide a mapping of a parent/child lineage for each of the 3D Gaussians in the LOD tree, the indexing performed using an indexing module on a non-transitory computer readable medium;
creating a working set_M, the working set_M configured for holding a query set of 3D Gaussians, where M is an integer increasing from 0 to x, M=0 is an initial query set corresponding to the initial set of 3D Gaussians, and M=x is a final query set of 3D Gaussians, the creating performed using a working set module on a non-transitory computer readable medium;
pairing a first 3D Gaussian with a neighboring 3D Gaussian to create a merged 3D Gaussian in the set of merged 3D Gaussians, the pairing occurring between 3D Gaussians in the working set_M, and starting within the source 3D Gaussians, the pairing including
   assessing the first 3D Gaussian and the neighboring 3D Gaussian for a sufficient similarity for the merging; and, if the first 3D Gaussian and the neighboring 3D Gaussian are sufficiently similar, then
   creating a respective merged 3D Gaussian by pairing the first 3D Gaussian; and,
   indexing the respective merged 3D Gaussian for a mapping of the parent/child lineage between the first 3D Gaussian, the neighboring 3D Gaussian and the merged 3D Gaussian;
   wherein, the pairing includes repeating the pairing until there are no remaining 3D Gaussians that are sufficiently similar for a further repeating of the pairing, and the pairing is performed using the merging module on a non-transitory computer readable medium.
updating the working set_M, the updating including (i) adding each merged 3D Gaussian to the working set_M, and (ii) removing the paired 3D Gaussians used to create the merged 3D Gaussian from the working set_M, each updating increasing the working set_M from M=0 to M=x, the updating performed using the working set module on a non-transitory computer readable medium;
linking each merged 3D Gaussian
   directly to the respective first 3D Gaussian and directly to the respective neighboring 3D Gaussian from which the merged 3D Gaussian was derived;
   directly to the respective first 3D Gaussian and indirectly to one or more descendants of the respective neighboring 3D Gaussian from which the merged 3D Gaussian was derived;
   indirectly to one or more descendants of the respective first 3D Gaussian and directly to the respective neighboring 3D Gaussian from which the merged 3D Gaussian was derived; or,
   indirectly to one or more descendants of the respective first 3D Gaussian and indirectly to the respective neighboring 3D Gaussian from which the merged 3D Gaussian was derived;
   wherein, each linking includes creating a branch in the LOD tree and storing the branch from each linking in the database for building the LOD tree, the linking performed using the indexing module on a non-transitory computer readable medium;

and,
encoding the LOD tree using an encoding module on a non-transitory computer readable medium.

In some embodiments, the method can further include modifying each merged 3D Gaussian, the modifying including adjusting one or more attributes in the set of 3D Gaussian attributes of each merged 3D Gaussian to geometrically and visually approximate the respective first 3D Gaussian and the respective neighboring 3D Gaussian merged to form the respective merged 3D Gaussian, the modifying performed using a modification module on a non-transitory computer readable medium.

One of skill will appreciate that, in many embodiments, the building of the LOD tree does not require a training, or a retraining, of the source 3D Gaussian data set. This flexibility allows application of the technologies taught herein with most any source 3D Gaussian data set.

In some embodiments, the methods of building an LOD tree can comprise building levels of Gaussians into an the N-ary LOD tree as a series of LOD_k levels from k=0 to k=T, the series of LOD_k levels having, for example, a bottom level of 3D Gaussian nodes, LOD_0, with a finest resolution, and a top level of 3D Gaussian nodes, LOD_T, with a coarsest resolution, the top level, LOD_T, composed of one or more root nodes, R_g. It should be appreciated that the choice of index format is not limited by any of the teachings provided herein, and is only set-forth to describe the methods and related systems. Any choice of index can be used to identify and track the lineage of each 3D Gaussian in the LOD trees.

The building can include storing 3D Gaussians in a database, and the storing including indexing each of the 3D Gaussians, G_g, during the building, the indexing proceeding in the building of the N-ary LOD tree in order from the LOD_0 level to the LOD_T level, each of the 3D Gaussians including a set of 3D Gaussian attributes including a center, a covariance, a color, and an opacity, the indexing providing mapping of a parent/child lineage of each Gaussian node from k=0 to k=T in the N-ary LOD tree, the indexing performed using an indexing module on a non-transitory computer readable medium.

The building can further include creating a working set_M, the working set_M configured for holding a query set of 3D Gaussians, such as the set of source 3D Gaussians, merged Gaussians, 3D Gaussian nodes, and combinations thereof, at a current LOD_k level, where M is an integer increasing from 0 to x, M=0 is an initial query set corresponding to the initial finest set of 3D Gaussian nodes. In some embodiments, M=0 is an initial query set at the LOD_0 level that contains the initial finest set of 3D Gaussian nodes, and M=x is a final query set used to create the one or more root nodes, R_g at the LOD_T level, the creating of the working set_M performed using a working set module on a non-transitory computer readable medium.

The building can further include pairing a first 3D Gaussian, G_a, with a neighboring 3D Gaussian, G_b, at the current LOD_k level, the pairing occurring between 3D Gaussians in the working set_M, and starting with the bottom level of 3D Gaussian nodes, LOD_0, and continuing level-by-level through LOD_T, the pairing performed using a merging module on a non-transitory computer readable medium. The pairing can include
querying the working set_M;
assessing G_a and G_b, for a compatibility;
determining whether G_a and G_b satisfy a similarity threshold_k for the current LOD_k level; and, if G_a and G_b are both compatible and meet the similarity threshold_k, then
creating a respective merged 3D Gaussian, G_ab; and,
indexing the respective merged 3D Gaussian, G_ab, as the respective merged 3D Gaussian, G_g, for the mapping of the parent/child lineage between G_a, G_b, and G_ab;
wherein, the pairing at the current LOD_k level includes repeating the pairing until there are no remaining 3D Gaussian pairs in the working set_M satisfying the similarity threshold_k for the current LOD_k level.

The building can further include updating the working set_M at the current LOD_k level, the updating including (i) adding each merged 3D Gaussian, G_ab, created at the current LOD_k level to the working set_M, and (ii) removing the paired 3D Gaussians, G_a and G_b, used to create the merged 3D Gaussian, G_ab, from the working set_M, the updating performed using a working set module on a non-transitory computer readable medium.

The building can further include modifying each merged 3D Gaussian, G_ab, the modifying including adjusting the one or more attributes in the set of 3D Gaussian attributes of each merged 3D Gaussian, G_ab, to geometrically and visually approximate the 3D Gaussians G_a and G_b, that were paired to form the merged 3D Gaussian, G_ab, the modifying performed using a modification module on a non-transitory computer readable medium.

The building can further include assigning the 3D Gaussians remaining in the working set_M after completion of the pairing and the modifying at the current LOD_k level as a set of 3D Gaussian nodes, G_(k+1)g, at a next coarser LOD_k+1 level, the assigning performed using the working set module on a non-transitory computer readable medium.

The building can further include linking each 3D Gaussian node in the set of 3D Gaussian nodes, G_(k+1)g, at the LOD_k+1 level directly to one or more 3D Gaussian nodes at the next finer LOD_k level from which the 3D Gaussian node in the set of 3D Gaussian nodes, G_(k+1)g, originated, each linking creating a branch in the N-ary LOD tree for storage in the database using the indexing module on a non-transitory computer readable medium.

The building can further include increasing the similarity threshold_k to a similarity threshold_k+1 for the LOD_k+1 level, resulting in the increasing in coarseness from the LOD_k level to the LOD_k+1 level for the rendering of the image.

The building can further include repeating (i) the pairing at the current LOD_k level, (ii) the updating of the working set_M at the current LOD_k level, (iii) the modifying of each merged 3D Gaussian, (iv) the assigning of the 3D Gaussians remaining in the working set_M as the set of 3D Gaussian nodes, G_(k+1)g, at the next coarser LOD_k+1 level, (v) the linking of the set of 3D Gaussian nodes, G_(k+1)g, at the LOD_k+1 level directly to the one or more 3D Gaussian nodes at the next finer LOD_k level from which the set of 3D Gaussian nodes, G_(k+1)g, originated, and (v) the increasing of the similarity threshold_k to the similarity threshold_k+1, the repeating performed in series starting at k=0 and progressing level-by-level until the one or more root nodes, R_g, are formed at LOD_T.

The building can further include encoding the N-ary LOD tree using an encoding module on a non-transitory computer readable medium.

In these methods, the building of the N-ary LOD tree does not require a training, or a retraining, of the source 3D Gaussian data set; and, the LOD_T level is a coarseness level of the one or more root nodes that satisfy one or more conditions that include a minimum 3D Gaussian count, a maximum 3D Gaussian count, the similarity threshold_T, or a combination thereof.

In some embodiments, the similarity threshold_k is a minimum required similarity between the first 3D Gaussian, G_a, and the neighboring 3D Gaussian, G_b, for the creating of the respective merged 3D Gaussian, G_ab at the LOD_k level, the similarity threshold based on a similarity measure that is a scalar number representing a generalized distance calculation that includes
the position of the center or centroid of the first 3D Gaussian, G_a;
the position of the respective center or centroid of the neighboring 3D Gaussian, G_b, at the LOD_k level;
the covariance of the first 3D Gaussian node, G_a, at the LOD_k level;
the covariance of the neighboring 3D Gaussian node, G_b, at the LOD_k level; and,
combinations thereof.

In some embodiments, the working set_M is a spatial index. Any spatial index preferred by the user can be configured for use with the technologies taught herein. In some embodiments, the working set_M is an octree or a kD tree.

In some embodiments, the adjusting in the modifying of each merged Gaussian, G_ab, further includes determining a respective target opacity for each merged Gaussian, G_ab, the respective target opacity representing
the opacities of the 3D Gaussians G_a and G_b, that were paired to form the merged Gaussian, G_ab;
the opacities of the one or more 3D Gaussian nodes at the next finer LOD_k level from which the merged Gaussian node, G_ab, originated;
or, a combination thereof;

In some embodiments, the adjusting in the modifying of each merged Gaussian, G_ab, further includes reshaping each merged 3D Gaussian, G_ab, to emulate the respective target opacity for each merged 3D Gaussian, G_ab. In some embodiments, the reshaping includes manipulating a mathematical function to change the shape of the Gaussian kernel of a respective merged 3D Gaussian, G_ab.

In some embodiments, the similarity threshold_k is a user-specified constant selected to preserve a desired level of detail at the LOD_k level; wherein,
similarity threshold_k=(similarity threshold_0)*power (coarsening factor, N)
where,
N ranges from 0 to T; and,
the coarsening factor ranges from 1.1 to 2.9.

The methods taught herein can include an encoding step to prepare the LOD tree for a use. In some embodiments, the encoding further includes
partitioning the 3D Gaussian nodes of the N-ary tree into a set of 3D Gaussian blocks, each block in the set of 3D Gaussian blocks encoded into (i) a data file or (ii) a data file section for a streaming of the 3D Gaussian data, a rendering of the 3D Gaussian data to create an image for display, or a combination thereof;
wherein, each block in the set of 3D Gaussian blocks is encoded into the data file using the one or more attributes.

The methods can include efficiently displaying a scene. In some embodiments, the methods include building an N-ary LOD tree of 3D Gaussian nodes; and, rendering a first scene, the rendering including selecting a reduced number of the 3D Gaussian nodes from the N-ary LOD tree to display the first scene from a first viewpoint. In some embodiments, the methods include building the N-ary LOD tree of 3D Gaussian nodes; rendering a first scene, the rendering including selecting a least possible reduced number of the 3D Gaussian nodes from the N-ary LOD tree to display the first scene from a first viewpoint; and, rendering a second scene, the rendering including selecting a least possible reduced number of the 3D Gaussian nodes from the N-ary LOD tree to display the second scene from a first viewpoint.

Methods of rendering the 3D Gaussian nodes in an N-ary LOD tree into an image for display can include, for example, using a top-down, recursive descent from the one or more root nodes at the LOD_T level for identifying at each point in the recursive descent an LOD_k level having a coarseness that satisfies a condition or set of conditions for the viewing position and desired resolution.

In some embodiments, the rendering methods can further comprise organizing the 3D Gaussian nodes in the N-ary LOD tree into a set of sorted rasterization groups from a perspective of a viewer of the image, the organizing including
sorting the 3D Gaussian nodes in the N-ary LOD tree by their relative position in the image as a first sorted rasterization group, and repeating the sorting with the remainder of the 3D Gaussian nodes in the N-ary tree to form the set of sorted rasterization groups from the perspective of the viewer of the image;
splatting and blending the 3D Gaussian nodes within each sorted rasterization group to create a respective single rendering primitive for each of the sorted rasterization groups to provide a total number of rendering primitives, each rendering primitive in the total number of rendering primitives having multiple 3D Gaussian splats; wherein, the sorting, splatting and blending reduces the total number of rendering primitives used in the rendering; and,
blending the reduced total number of rendering primitives into a framebuffer for the rendering.

In some embodiments, the rendering can include:
obtaining the encoded N-ary LOD tree;
downloading and decoding the first block of the N-ary LOD tree containing the one or more root nodes at LOD_T;
sorting the 3D Gaussian blocks by order of streaming priority, the sorting including prioritizing each 3D Gaussian block by the distance of the 3D Gaussian block from a viewing position;
using a top-down, recursive descent from the one or more root nodes at the LOD_T level for identifying at each point in the recursive descent an LOD_k level having a coarseness that satisfies the condition or set of conditions for the viewing position and desired resolution.

In some embodiments, the rendering can further include organizing the 3D Gaussian nodes into a set of sorted rasterization groups, the organizing including
sorting the 3D Gaussian nodes in the N-ary LOD tree by their relative position in the image as a first sorted rasterization group, and repeating the sorting with the remainder of the 3D Gaussian nodes in the N-ary tree to form the set of sorted rasterization groups from the perspective of the viewer of the image;
splatting and blending the 3D Gaussian nodes within each sorted rasterization group to create a respective single rendering primitive for each of the sorted rasterization groups to provide a total number of rendering primitives, each rendering primitive in the total number of rendering primitives having multiple 3D Gaussian splats; wherein, the sorting, splatting and blending reduces the total number of rendering primitives used in the rendering; and,
blending the reduced total number of rendering primitives into a framebuffer for the rendering.

In some embodiments, the methods include further enhancing a compression performance; wherein,
the pairing further includes prioritizing the pairing in an order of priority of similarity, where the most similar G_a and G_b has the highest priority and is paired first, and the least similar G_a and G_b has the lowest priority and is paired last; and,
the encoding further includes ordering at least a portion of the 3D Gaussian nodes in the N-ary LOD tree within each 3D Gaussian block according to a traversal order of the N-ary LOD tree that reflects the pairing of similar 3D Gaussians first, such that consecutively ordered 3D Gaussian nodes in the N-ary LOD tree are spatially correlated to enhance the compression performance.

And, in some embodiments, the methods further include filtering each 3D Gaussian node in the N-ary LOD tree to remove noise, the filtering including applying a Gaussian blur to one or more 3D Gaussian nodes in the N-ary tree, the filtering performed using the modification module on a non-transitory computer readable medium.

Systems are provided having a processor and a memory configured for each embodiment taught herein. Moreover, the memory of the systems has modules, each of the modules configured with instructions for the processor to perform one or more respective function.

In some embodiments, a system for creating an LOD tree for an image display is provided. The system can include a processor and a memory. The memory can include
a database that is configured for storing system data;
an indexing module configured with instructions to provide a mapping of a parent/child lineage following a pairing of 3D Gaussians in an LOD tree;
a working set module configured with instructions for (i) holding a query set of 3D Gaussians in a working set of 3D Gaussians for use in the pairing; and (ii) updating the working set of 3D Gaussians, the updating including (i) adding a merged 3D Gaussian to the working set, and (ii) removing a first 3D Gaussian that was paired with a neighboring 3D Gaussian to create the merged 3D Gaussian;
a merging module configured with
   (i) instructions for the pairing, the pairing including merging the first 3D Gaussian with the neighboring 3D Gaussian to create the merged 3D Gaussian;
   (ii) instructions for linking the merged 3D Gaussian
      directly to the respective first 3D Gaussian and directly to the respective neighboring 3D Gaussian from which the merged 3D Gaussian was derived;
      directly to the respective first 3D Gaussian and indirectly to one or more descendants of the respective neighboring 3D Gaussian from which the merged 3D Gaussian was derived;
      indirectly to one or more descendants of the respective first 3D Gaussian and directly to the respective neighboring 3D Gaussian from which the merged 3D Gaussian was derived; or,
   indirectly to one or more descendants of the respective first 3D Gaussian and indirectly to the respective neighboring 3D Gaussian from which the merged 3D Gaussian was derived;
   and
   (iii) instructions for storing the branch in the LOD tree in the database;
      wherein, each linking includes creating a branch in the LOD tree and storing the branch from each linking in the database for building the LOD tree, the linking performed using the indexing module on a non-transitory computer readable medium;
and,
an encoding module configured with instructions for encoding the LOD tree.

In some embodiments, the systems can be further configured for rendering an image display from the LOD tree. As such, the systems can further include
a rendering module configured with instructions for rendering an image from one or more root nodes of the LOD tree to begin developing the image;
a traversing module configured with instructions for traversing the LOD tree, the traversing using a top-down, recursive descent from the one or more root nodes through the parent/child lineage in the LOD tree to select 3D Gaussians that provide a desired resolution; and,
a streaming module configured for managing a streaming of the image for a display.

### BRIEF DESCRIPTION OF THE DRAWINGS

FIG. 1 is a flowchart that illustrates a general method of building an LOD tree, according to some embodiments.

FIG. 2 is a flowchart that illustrates a general method of rendering an image from an LOD tree, according to some embodiments.

FIGS. 3A and 3B show a simplified construction of an LOD tree and conversion of the LOD tree into an N-ary LOD tree, according to some embodiments.

FIGS. 4A and 4B provide a decision flowchart for a building of an LOD tree, according to some embodiments.

FIG. 5 illustrates a processor-memory diagram to describe components of systems taught herein, according to some embodiments.

FIG. 6 shows how a network may be used for the systems and methods taught herein, in some embodiments.

FIG. 7 is a representation of a “fat” Gaussian family of curves, according to some embodiments.

FIGS. 8A and 8B provide screenshots of partial and fully downloaded views of a scene using a web-based service, according to some embodiments.

### DETAILED DESCRIPTION

Systems and methods are provided for constructing a level-of-detail (LOD) hierarchy for 3D Gaussian representations. The LOD hierarchy can be referred to as “an LOD tree”, “a 3D Gaussian LOD tree”, “an N-ary LOD tree”, “a 3D Gaussian N-ary LOD tree”, “a tree”, “an N-ary tree”, and the like, to describe embodiments taught herein. In some embodiments, each of these terms can be used interchangeably.

Systems and methods for building LOD trees from 3D Gaussians are provided. The LOD trees include a set of source 3D Gaussians and a set of merged 3D Gaussians derived from the source set of 3D Gaussians during the building. In some embodiments, the method comprises obtaining the source set of 3D Gaussians, and building the LOD tree from the source set of 3D Gaussians and their progeny, each of the progeny being directly or indirectly linked one or more respective descendants, the linking providing a “resolution pathway” that configures the LOD tree to allow for a selection of 3D Gaussians that provide any of a variety of desired resolutions for the rendering of an image.

In some embodiments, the building of an LOD includes (i) creating a working set of 3D Gaussians that initially include the source of 3D Gaussians; (ii) merging, or “pairing”, sufficiently similar 3D Gaussians in the source set of 3D Gaussians to create merged 3D Gaussians; (iii) updating the working set to add the merged 3D Gaussians and remove the 3D Gaussians that were merged to create the 3D Gaussians; (iv) repeating the merging and the updating among all 3D Gaussians in the updated working set of 3D Gaussians and continuing the repeating and updating until there are no sufficiently similar 3D Gaussians for further merging; (v) linking all merged 3D Gaussians to a plurality of their respective descendant 3D Gaussians to build an LOD tree. It should be appreciated that the “similarity” can be determined by comparing 3D Gaussian attributes of a first 3D Gaussian and a neighboring 3D Gaussian, and if the similarity is sufficient, the first 3D Gaussian and the neighboring 3D Gaussian can be paired to create the merged 3D Gaussian. When the repeating and updating are complete in the LOD tree, one or more “root nodes” are the result and represent the coarsest level of resolution. The set of source 3D Gaussians represent the finest level of resolution. The linking between a root node and it's descendants provides a pathway through the tree for that respective root node that allows for a selection of a desired resolution when rendering an image from the LOD tree.

The systems and methods can be used, for example, to generate a continuous, streaming-compatible LOD hierarchy from an arbitrary finished 3D Gaussian set. Methods can include performing offline, data-driven simplification (merging/clustering) of 3D Gaussians from, and derived from, the arbitrary finished 3D Gaussian set while recording explicit parent→child lineage. At runtime, the renderer can select resolution per region and progressively refine as finer data streams in without retraining, and without access to, training images. In some embodiments, this can be referred to a post-training auto-LOD with lineage (for continuous LOD+progressive streaming), as opposed to competing methods that include:
tiled/top-down subdivision (needs authored/multi-res inputs; box boundaries), or
training-time/retraining-based hierarchy construction (needs images/optimization; expensive; not applicable to arbitrary existing 3DGS outputs).

One of skill will appreciate such embodiments that provide a post-training hierarchical simplification of 3DGS that preserves lineage to enable continuous LOD selection and progressive streaming.

These systems and methods use a bottom-up merging strategy, rather than the conventional top-down partitioning approaches. One of skill will appreciate that the building of the LOD tree using the technologies provided herein does not require a training, or a retraining, of the source 3D Gaussian data set. Systems containing a processor and a memory having all of the above modules are provided. The process of building the LOD tree starting from a set of source 3D Gaussians can be referred to as a “bottom up” construction, and all systems and methods herein are directed to such a “bottom-up construction” of LOD trees. Any of the systems and methods taught herein can be used create N-ary LOD trees from a source 3D Gaussian data set.

In some embodiments, the LOD trees taught herein can be built “level-by-level” starting with a source 3D Gaussian data set that serves as a first or “bottom” level of nodes, and the second level of nodes is derived from a pairing of similar nodes in the first level of nodes, the third level of nodes is derived from a pairing of similar nodes in the second level, and so on. This type of construction of the LOD trees can be referred to “a stacked tree” in some embodiments.

The LOD trees can be built starting with a source 3D Gaussian data set and, in some embodiments, the trees are build level-by-level. In some embodiments, however, the trees are not built “level-by-level”. Rather, they are built by (i) creating a working set of the source 3D Gaussians; (ii) pairing similar 3D Gaussians in the working set to create merged 3D Gaussians; (iii) updating the working set by adding the merged 3D Gaussians to the working set and removing the paired 3D Gaussians from the working set; (iv) repeating the pairing of similar 3D Gaussians in the working set; and (v) repeating the updating of the working set; and (vi) repeating the pairing until there are no more pairs of similar 3D Gaussians in the working set. This type of construction of the LOD trees can be referred to “free-form” tree, in some embodiments, as they are not constructed level-by-level as set-forth in some embodiments herein.

As such, in some embodiments, an N-ary LOD tree is created with the most detailed representation of the dataset at the bottom of the tree as 3D Gaussian nodes. This bottom level of 3D Gaussian nodes can be referred to as “leaf nodes”. Similar Gaussians in these 3D Gaussian nodes at the bottom of the N-ary LOD tree are iteratively merged using a predefined similarity measure to result in the creation of a next level of 3D Gaussian nodes that is stacked on the bottom level. Each next level is built from the prior level in the same way until reaching the top of the N-ary LOD tree where the process stops with one or more “root nodes”. Each next level of the N-ary LOD tree is composed of “parent” nodes having a lineage to the “child” nodes in the preceding level, each of the parent nodes deriving from the iteratively merging that began with respective child nodes from the preceding level. The systems and methods track this lineage between the nodes using “branches” in the tree. In some embodiments, the N-ary LOD tree can be referred to as “an N-ary tree”, “an LOD tree”, “a tree”, and the like. In some embodiments, these terms can be used interchangeably. In some embodiments, the 3D Gaussians can be referred to as “Gaussians”. Likewise, in some embodiments, the 3D Gaussian nodes can be referred to as “Gaussian nodes” or “nodes”. In some embodiments, the 3D Gaussian nodes can be referred to as “3D Gaussians”. As will be apparent from the teachings herein, all 3D Gaussian nodes are 3D Gaussians, but not all 3D Gaussians are 3D Gaussian nodes.

The systems and methods used herein can build LOD trees from “a source 3D Gaussian data set”, which can also be referred to as “a set of source 3D Gaussians”, “a source set of 3D Gaussians”, “original set of source 3D Gaussians”, “source 3D Gaussians”, “source Gaussians”, “source 3D Gaussian nodes”, “source Gaussian nodes”, “source nodes”, and any combination thereof. Likewise, the 3D Gaussian datasets used to create the N-ary LOD trees herein can also be referred to as “an existing 3D Gaussian dataset” in some embodiments, “an original 3D Gaussian dataset” in some embodiments, and “a source 3D Gaussian dataset” in some embodiments. In some embodiments, these terms can be used interchangeably.

In some embodiments, the systems and methods can be configured to increase the coarseness of the 3D Gaussian nodes in the N-ary LOD tree from one level to the next level as the process progresses in series level-by-level from the bottom up. In some embodiments, the systems and methods can be configured to increase the coarseness of the 3D Gaussian nodes in the N-ary LOD tree.

One of skill will appreciate that the systems and methods allow display of a scene or series of scenes using a reduced number of Gaussians for a given viewpoint. This is highly desirable, because the total number of Gaussians can otherwise be so large that it would be difficult-to-impossible to display the total number of 3D Gaussians without the N-ary LOD tree. In fact, it can be difficult-to-impossible to even download the total number of 3D Gaussians completely. One of skill in the art will appreciate having such N-ary LOD trees, as the assemblage of the N-ary LOD tree allows for a rendering of a scene or series of scenes where the rendering of the scene or series of scenes for selecting a reduced number of the 3D Gaussian nodes from the N-ary LOD tree to display the scene or scenes from any desired viewpoint.

It should be appreciated that the hierarchy provided by the structure of the N-ary LOD tree is compact and scalable, naturally adapting to the underlying scene data. Unlike conventional methods that use spatial partitions, such as bounding volume hierarchies, the instant technologies use a data-driven similarity measure and thresholds. In some embodiments, the data-driven similarity measures and thresholds can include the consideration of both geometric and color information, resulting in more semantically meaningful clusters.

The systems and methods can further include Gaussian filtering to improve rendering quality and user experience. In some embodiments, the method further applies Gaussian filtering at coarser levels to remove high-frequency detail not appropriate for low-resolution viewing. This supports anti-aliasing, facilitates merging and enables progressive streaming, where coarse representations are displayed first and refined as finer details become available.

A highly desirable feature is that the instant technologies are compatible with existing 3D Gaussian datasets. The systems and methods do not require retraining or access to original image data, making the instant technologies suitable for post-processing and scalable deployment in real-time applications.

Each 3D Gaussian discussed herein can be defined by any one or any combination of 3D Gaussian “attributes”. The attributes can be a set of attributes, and the set of attributes can include, for example, any combination of (i) a center position (μ), (ii) a covariance matrix which can be expressed as Σ=RSSR, in some embodiments, where R is a rotation matrix and S is a diagonal scaling matrix, (iii) color, (iv) opacity, (v) spherical harmonics (or any other basis) coefficients for view-dependent color. It should be appreciated by the skilled artisan that the one or combination of attributes used in the instant technologies can be subjective to the particular application for which a system of method is configured to address.

In some embodiments, the 3D Gaussians are merged in order of priority as each level of the N-ary LOD tree built. The merger of the 3D Gaussians can occur, for example, in a series that progresses from a most similar 3D Gaussian pair to a least similar 3D Gaussian pair.

The “similarity” between 3D Gaussians can be assessed using a “similarity measure”. In some embodiments, the similarity measure is one or a combination of the 3D Gaussian attributes. And, in some embodiments, the similarity threshold is used to determine whether 3D Gaussians are similar enough to be merged. The similarity threshold can be defined for its “current level” in the N-ary LOD tree to define a coarseness for its current level. As such, it can be appreciated that the similarity threshold can be defined independently for each level of the tree, including increasing the similarity threshold to increase for each consecutive level in the N-ary LOD tree. In some embodiments, the similarity threshold increases at each level to ensure that the coarseness, the amount of detail provided by the respective level, decreases level-by-level. In some embodiments, the amount of detail decreases exponentially with each coarser level. In some embodiments, the similarity threshold can increase level-by-level by a fixed factor to configure the decrease in the amount of detail that is provided level-by-level from the bottom of the N-ary LOD tree to the top of the N-ary LOD tree. In some embodiments, the similarity threshold can increase level-by-level by a factor selected from the group consisting of 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or any factor therein in increments of 0.01.

One of skill will appreciate that several metrics can be used to define “similarity” between 3D Gaussians. In some embodiments, a generalized distance can be used. In some embodiments, a geometric distance can be used. In some embodiments, Kullback-Leibler divergence can be used. In some embodiments, Bhattacharyya distance can be used. In some embodiments, Hellinger distance can be used. And, in some embodiments, Wasserstein distance can be used.

The building of the N-ary LOD tree includes queries of the attributes of many 3D Gaussians for each merging of 3D Gaussians that occurs iteratively from the bottom of the tree to the top of the tree, level-by-level. In some embodiments, a “working set” of 3D Gaussians is created and updated to facilitate faster queries of the 3D Gaussians for the merging. In some embodiments, the working set can be a spatial index. The working set can be configured, for example, to (i) hold all Gaussians that have not yet been merged at the current level (ii) add “parent” 3D Gaussians created from respective mergers of “child” 3D Gaussians, and (iii) remove the child 3D Gaussians merged to create their respective parent 3D Gaussians. In some embodiments, the spatial index can include an octree. In some embodiments, the spatial index can include a kD tree. In some embodiments, the spatial index can include a uniform grid. In some embodiments, the spatial index can include a hash grid.

To improve rendering quality and user experience, the systems and methods can further include Gaussian filtering at coarser levels to remove high-frequency detail not appropriate for low-resolution viewing. This supports anti-aliasing, facilitates merging and enables progressive streaming, where coarse representations are displayed first and refined as finer details become available.

One of skill will appreciate that the systems and methods can be compatible with existing 3D Gaussian datasets. Moreover, the systems and methods do not require retraining or access to original image data, making it suitable for post-processing and scalable deployment in real-time applications.

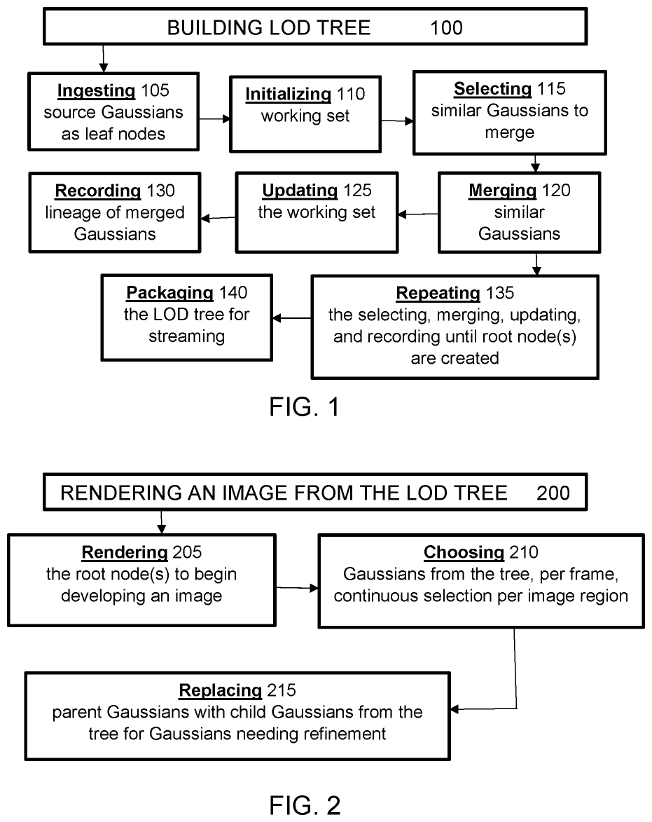

FIG. 1 is a flowchart that illustrates a general method of building an LOD tree, according to some embodiments. This method 100 includes ingesting 105 a set of source Gaussians as leaf nodes in the tree, each of the 3D Gaussians having a position and a set of 3D Gaussian attributes including a center, a covariance, a color, and an opacity. The method 100 also includes initializing 110 a working set of 3D Gaussians, the working set initialized with the set of source 3D Gaussians as “leaf nodes” or “leaf Gaussians” having the highest level of resolution provided by the tree. The method 100 also includes selecting 115 similar Gaussians to merge by determining whether a pair of Gaussians are sufficiently similar to merge, the selecting using a data-driven locality query that can be referred to as a “neighborhood query” or “spatial neighborhood query”. The method 100 also includes merging 120 of similar Gaussians as “child” Gaussians that are paired in the merging to form a respective “parent” Gaussian or “merged Gaussian” that is a “coarser” Gaussian approximation of the paired child Gaussians. The method 100 also includes updating 125 the working set, the updating including adding the parent Gaussian to the working set and removing the child Gaussians merged to create the parent Gaussian. The method 100 also includes recording 130 the child-to-parent lineage for each merging 120 in the tree, the recording 130 being a linking of the lineage throughout the tree, each linking configured as a branch in the tree that is operable for providing a tracked path from each merged or parent Gaussian to the child Gaussians from which the merged or parent Gaussian was derived. The method 100 also includes repeating 135 the selecting, merging, updating, and recording until the root node(s) are created. Finally, the method 100 also includes packaging 140 the LOD tree for streaming. The packaging 140 can include encoding the LOD tree. The packaging, for example, might include partitioning Gaussians into streamable chunks, storing metadata needed to refine the LOD tree which might include, for example, error metrics, child pointers, and the like, or a combination thereof.

One of skill will appreciate that it is the tracked path that allows the LOD tree to facilitate creating a desired image resolution when rendering an image by selecting from the different amounts of image coarseness made available throughout the tree from the merging 120. It should be appreciated that the method can include modifying each parent Gaussian to preserve, or approximate, one or more attributes from the respective child Gaussians that provided a desired geometry and/or appearance. An example of an attribute that can be preserved, or approximated, from the modifying is opacity.

In some embodiments, the selecting can include an “error proxy” appropriate for Gaussians, for example, “can these Gaussians be represented by fewer Gaussians without unacceptable visual error?”

In some embodiments, the method comprises obtaining the source set of 3D Gaussians, and building the LOD tree, the building including
storing 3D Gaussians in a database, where the term “database” can be used to refer to a traditional database or an in-memory database (IMDB), RAM, etc, in some embodiments, each of the 3D Gaussians including a set of attributes, the storing including indexing each 3D Gaussian in the source set of 3D Gaussians, and each 3D Gaussian in the set of merged 3D Gaussians derived from the source set of 3D Gaussians during the building, the indexing configured to provide a mapping of a parent/child lineage for each of the 3D Gaussians in the LOD tree, the indexing performed using an indexing module on a non-transitory computer readable medium;
creating a working set_M, the working set_M configured for holding a query set of 3D Gaussians, where M is an integer increasing from 0 to x, M=0 is an initial query set corresponding to the initial set of 3D Gaussians, and M=x is a final query set of 3D Gaussians, the creating performed using a working set module on a non-transitory computer readable medium;
pairing a first 3D Gaussian with a neighboring 3D Gaussian to create a merged 3D Gaussian in the set of merged 3D Gaussians, the pairing occurring between 3D Gaussians in the working set_M, and starting within the source 3D Gaussians, the pairing including
   assessing the first 3D Gaussian and the neighboring 3D Gaussian for a sufficient similarity for the merging; and, if the first 3D Gaussian and the neighboring 3D Gaussian are sufficiently similar, then
   creating a respective merged 3D Gaussian by pairing the first 3D Gaussian; and, indexing the respective merged 3D Gaussian for a mapping of the parent/child lineage between the first 3D Gaussian, the neighboring 3D Gaussian and the merged 3D Gaussian;
   wherein, the pairing includes repeating the pairing until there are no remaining 3D Gaussians that are sufficiently similar for a further repeating of the pairing, and the pairing is performed using the merging module on a non-transitory computer readable medium.
updating the working set_M, the updating including (i) adding each merged 3D Gaussian to the working set_M, and (ii) removing the paired 3D Gaussians used to create the merged 3D Gaussian from the working set_M, each updating increasing the working set_M from M=0 to M=x, the updating performed using the working set module on a non-transitory computer readable medium;
linking each merged 3D Gaussian
   directly to the respective first 3D Gaussian and directly to the respective neighboring 3D Gaussian from which the merged 3D Gaussian was derived;
   directly to the respective first 3D Gaussian and indirectly to one or more descendants of the respective neighboring 3D Gaussian from which the merged 3D Gaussian was derived;
   indirectly to one or more descendants of the respective first 3D Gaussian and directly to the respective neighboring 3D Gaussian from which the merged 3D Gaussian was derived; or,
   indirectly to one or more descendants of the respective first 3D Gaussian and indirectly to the respective neighboring 3D Gaussian from which the merged 3D Gaussian was derived;
   wherein, each linking includes creating a branch in the LOD tree and storing the branch from each linking in the database for building the LOD tree, the linking performed using the indexing module on a non-transitory computer readable medium;
and,
encoding the LOD tree using an encoding module on a non-transitory computer readable medium.

In some embodiments, the method can further include modifying each merged 3D Gaussian, the modifying including adjusting one or more attributes in the set of 3D Gaussian attributes of each merged 3D Gaussian to geometrically and visually approximate the respective first 3D Gaussian and the respective neighboring 3D Gaussian merged to form the respective merged 3D Gaussian, the modifying performed using a modification module on a non-transitory computer readable medium.

One of skill will appreciate that, in many embodiments, the building of the LOD tree does not require a training, or a retraining, of the source 3D Gaussian data set. This flexibility allows application of the technologies taught herein with most any source 3D Gaussian data set.

The process of building the LOD tree starting from a set of source 3D Gaussians can be referred to as a “bottom-up” construction for the systems and methods taught herein. The term “bottom-up” can sometimes refer to a conceptual orientation of the LOD tree, and the location of the data in the LOD tree. For example, the base of the LOD tree can be at the bottom of a conceptual orientation of the data, and the construction of the tree starts at the bottom of the tree from the set of source 3D Gaussians and stops at the top of the tree with merged Gaussians derived from the source set of 3D Gaussians. And, sometimes, the “bottom-up” can refer to merely starting with the set of source 3D Gaussians from any conceptual orientation, the LOD tree growing in any direction, where the “start” of the construction of the tree refers to the “bottom” of the LOD tree, and the “stop” of the construction of the tree can be referred to as the “top” of the LOD tree. And, it should be appreciated that any of the systems and methods taught herein can be used create N-ary LOD trees from a source 3D Gaussian data set.

The LOD trees taught herein can be used for rendering an image. In some embodiments, an image can be rendered using any one or any combination 3D Gaussians from a bottom of the N-ary LOD tree used for rendering the image with a finest level of detail to a top of the N-ary LOD tree used for rendering the image with a coarsest level of detail. It should be appreciated that the LOD tree can have levels of detail, wherein each level of the N-ary LOD tree from the bottom of the tree to the top of the tree can be configured for an increasing in coarseness for the rendering of the image. As such, it should be appreciated that the N-ary LOD tree can provide a bottom-up level-of-detail (LOD) hierarchy for rendering the image with a desired level of coarseness. One of skill will appreciate that, using the technologies provided herein, those of skill are now able to descend to different depths of the tree at different places to obtain a selection (mathematically a “cut” of the tree) that has varying resolutions in different parts of the scene, depending on what the particular viewing parameters are (camera position, image resolution, etc).

In some embodiments, the methods of building an LOD tree can comprise building levels of Gaussians into an the N-ary LOD tree as a series of LOD_k levels from k=0 to k=T, the series of LOD_k levels having, for example, a bottom level of 3D Gaussian nodes, LOD_0, with a finest resolution, and a top level of 3D Gaussian nodes, LOD_T, with a coarsest resolution, the top level, LOD_T, composed of one or more root nodes, R_g. It should be appreciated that the choice of index format is not limited by any of the teachings provided herein, and is only set-forth to describe the methods and related systems. Any choice of index can be used to identify and track the lineage of each 3D Gaussian in the LOD trees.

The building can include storing 3D Gaussians in a database, and the storing including indexing each of the 3D Gaussians, G_g, during the building, the indexing proceeding in the building of the N-ary LOD tree in order from the LOD_0 level to the LOD_T level, each of the 3D Gaussians including a set of 3D Gaussian attributes including a center, a covariance, a color, and an opacity, the indexing providing mapping of a parent/child lineage of each Gaussian node from k=0 to k=T in the N-ary LOD tree, the indexing performed using an indexing module on a non-transitory computer readable medium.

The building can further include creating a working set_M, the working set_M configured for holding a query set of 3D Gaussians, such as the set of source 3D Gaussians, merged Gaussians, 3D Gaussian nodes, and combinations thereof, at a current LOD_k level, where M is an integer increasing from 0 to x, M=0 is an initial query set corresponding to the initial finest set of 3D Gaussian nodes. In some embodiments, M=0 is an initial query set at the LOD_0 level that contains the initial finest set of 3D Gaussian nodes, and M=x is a final query set used to create the one or more root nodes, R_g at the LOD_T level, the creating of the working set_M performed using a working set module on a non-transitory computer readable medium.

The building can further include pairing a first 3D Gaussian, G_a, with a neighboring 3D Gaussian, G_b, at the current LOD_k level, the pairing occurring between 3D Gaussians in the working set_M, and starting with the bottom level of 3D Gaussian nodes, LOD_0, and continuing level-by-level through LOD_T, the pairing performed using a merging module on a non-transitory computer readable medium. The pairing can include
querying the working set_M;
assessing G_a and G_b, for a compatibility;
determining whether G_a and G_b satisfy a similarity threshold_k for the current LOD_k level; and, if G_a and G_b are both compatible and meet the similarity threshold_k, then
creating a respective merged 3D Gaussian, G_ab; and,
indexing the respective merged 3D Gaussian, G_ab, as the respective merged 3D Gaussian, G_g, for the mapping of the parent/child lineage between G_a, G_b, and G_ab;
wherein, the pairing at the current LOD_k level includes repeating the pairing until there are no remaining 3D Gaussian pairs in the working set_M satisfying the similarity threshold_k for the current LOD_k level.

The building can further include updating the working set_M at the current LOD_k level, the updating including (i) adding each merged 3D Gaussian, G_ab, created at the current LOD_k level to the working set_M, and (ii) removing the paired 3D Gaussians, G_a and G_b, used to create the merged 3D Gaussian, G_ab, from the working set_M, the updating performed using a working set module on a non-transitory computer readable medium.

The building can further include modifying each merged 3D Gaussian, G_ab, the modifying including adjusting the one or more attributes in the set of 3D Gaussian attributes of each merged 3D Gaussian, G_ab, to geometrically and visually approximate the 3D Gaussians G_a and G_b, that were paired to form the merged 3D Gaussian, G_ab, the modifying performed using a modification module on a non-transitory computer readable medium.

The building can further include assigning the 3D Gaussians remaining in the working set_M after completion of the pairing and the modifying at the current LOD_k level as a set of 3D Gaussian nodes, G_(k+1)g, at a next coarser LOD_k+1 level, the assigning performed using the working set module on a non-transitory computer readable medium.

The building can further include linking each 3D Gaussian node in the set of 3D Gaussian nodes, G_(k+1)g, at the LOD_k+1 level directly to one or more 3D Gaussian nodes at the next finer LOD_k level from which the 3D Gaussian node in the set of 3D Gaussian nodes, G_(k+1)g, originated, each linking creating a branch in the N-ary LOD tree for storage in the database using the indexing module on a non-transitory computer readable medium.

The building can further include increasing the similarity threshold_k to a similarity threshold_k+1 for the LOD_k+1 level, resulting in the increasing in coarseness from the LOD_k level to the LOD_k+1 level for the rendering of the image.

The building can further include repeating (i) the pairing at the current LOD_k level, (ii) the updating of the working set_M at the current LOD_k level, (iii) the modifying of each merged 3D Gaussian, (iv) the assigning of the 3D Gaussians remaining in the working set_M as the set of 3D Gaussian nodes, G_(k+1)g, at the next coarser LOD_k+1 level, (v) the linking of the set of 3D Gaussian nodes, G_(k+1)g, at the LOD_k+1 level directly to the one or more 3D Gaussian nodes at the next finer LOD_k level from which the set of 3D Gaussian nodes, G_(k+1)g, originated, and (v) the increasing of the similarity threshold_k to the similarity threshold_k+1, the repeating performed in series starting at k=0 and progressing level-by-level until the one or more root nodes, R_g, are formed at LOD_T.

The building can further include encoding the N-ary LOD tree using an encoding module on a non-transitory computer readable medium.

In these methods, the building of the N-ary LOD tree does not require a training, or a retraining, of the source 3D Gaussian data set; and, the LOD_T level is a coarseness level of the one or more root nodes that satisfy one or more conditions that include a minimum 3D Gaussian count, a maximum 3D Gaussian count, the similarity threshold_T, or a combination thereof.

In some embodiments, the similarity threshold_k is a minimum required similarity between the first 3D Gaussian, G_a, and the neighboring 3D Gaussian, G_b, for the creating of the respective merged 3D Gaussian, G_ab at the LOD_k level, the similarity threshold based on a similarity measure that is a scalar number representing a generalized distance calculation that includes
the position of the center or centroid of the first 3D Gaussian, G_a;
the position of the respective center or centroid of the neighboring 3D Gaussian, G_b, at the LOD_k level;
the covariance of the first 3D Gaussian node, G_a, at the LOD_k level;
the covariance of the neighboring 3D Gaussian node, G_b, at the LOD_k level; and,
combinations thereof.

In some embodiments, the working set_M is a spatial index. Any spatial index preferred by the user can be configured for use with the technologies taught herein. In some embodiments, the working set_M is an octree or a kD tree. The ordinary artisan will recognize that a 3D spatial index might also include, for example, an R-tree, or perhaps specialized or hybrid structures such as a bounding volume hierarchy (BVH), a binary space partitioning (BSP) tree, a grid such as a hash grid, and the like. A spatial index can be used either alone or in combination with other partitioning or space partitioning methods, in some embodiments, to improve performance.

In some embodiments, the similarity measure further includes a semantic measure of each 3D Gaussian, the semantic measure including color, opacity, or a combination thereof. The ordinary artisan will appreciate that a “semantic measure” of a 3D Gaussian can refer to the annotation, classification, or identification of semantic information, where the semantic information might include, for example, object class, label, or functional property associated with a 3D Gaussian in a 3D Gaussian Splatting (3DGS) scene representation. Such information can be used to link purely geometric and visual attributes, for example, position, color, and covariance (which includes the shape of the Gaussian kernel for a 3D Gaussian) to a meaningful concept for use with the technologies taught herein.

In some embodiments, the adjusting in the modifying of each merged Gaussian, G_ab, further includes determining a respective target opacity for each merged Gaussian, G_ab, the respective target opacity representing
the opacities of the 3D Gaussians G_a and G_b, that were paired to form the merged Gaussian, G_ab;
the opacities of the one or more 3D Gaussian nodes at the next finer LOD_k level from which the merged Gaussian node, G_ab, originated;
or, a combination thereof;

In some embodiments, the adjusting in the modifying of each merged Gaussian, G_ab, further includes reshaping each merged 3D Gaussian, G_ab, to emulate the respective target opacity for each merged 3D Gaussian, G_ab. In some embodiments, the reshaping includes manipulating a mathematical function to change the shape of the Gaussian kernel of a respective merged 3D Gaussian, G_ab.

In some embodiments, the similarity threshold_k is a user-specified constant selected to preserve a desired level of detail at the LOD_k level; wherein,
similarity threshold_k=(similarity threshold_0)*power (coarsening factor, N)
where,
N ranges from 0 to T; and,
the coarsening factor ranges from 1.1 to 2.9.

It should be appreciated that the coarsening can include an increase that is linear, non-linear, or a combination thereof, in an LOD tree. In some embodiments, the coarsening can include an increase that is exponential in an LOD tree. In some embodiments, the coarsening factor used to increase the coarsening in an LOD tree can range from 1.2 to 2.8, from 1.3 to 2.7, from 1.4 to 2.6 from 1.5 to 2.5, from 1.6 to 2.4, for 1.7 to 2.3, from 1.8 to 2.3, from 1.9 to 2.2, from 2.0 to 2.1, or any amount or range therein in increments of 0.01. In some embodiments, the coarsening factor can be 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or any amount or range therein in increments of 0.01.

The methods taught herein can include an encoding step to prepare the LOD tree for a use. In some embodiments, the encoding further includes
partitioning the 3D Gaussian nodes of the N-ary tree into a set of 3D Gaussian blocks, each block in the set of 3D Gaussian blocks encoded into (i) a data file or (ii) a data file section for a streaming of the 3D Gaussian data, a rendering of the 3D Gaussian data to create an image for display, or a combination thereof;
wherein, each block in the set of 3D Gaussian blocks is encoded into the data file using the one or more attributes.

In some embodiments, the encoding further comprises encoding the one or more attributes of the consecutively ordered 3D Gaussian nodes using predictive coding, delta coding, entropy coding, or a combination thereof, based on the spatial correlation of the consecutively ordered 3D Gaussian nodes. The encoding facilitates transmission of the 3D Gaussians to the rendering device used in the rendering of the 3D Gaussians into an image for display.

The methods can include efficiently displaying a scene. In some embodiments, the methods include building an N-ary LOD tree of 3D Gaussian nodes; and, rendering a first scene, the rendering including selecting a reduced number of the 3D Gaussian nodes from the N-ary LOD tree to display the first scene from a first viewpoint. In some embodiments, the methods include building the N-ary LOD tree of 3D Gaussian nodes; rendering a first scene, the rendering including selecting a least possible reduced number of the 3D Gaussian nodes from the N-ary LOD tree to display the first scene from a first viewpoint; and, rendering a second scene, the rendering including selecting a least possible reduced number of the 3D Gaussian nodes from the N-ary LOD tree to display the second scene from a first viewpoint.

Methods of rendering the 3D Gaussian nodes in an N-ary LOD tree into an image for display can include, for example, using a top-down, recursive descent from the one or more root nodes at the LOD_T level for identifying at each point in the recursive descent an LOD_k level having a coarseness that satisfies a condition or set of conditions for the viewing position and desired resolution.

In some embodiments, the rendering methods can further comprise organizing the 3D Gaussian nodes in the N-ary LOD tree into a set of sorted rasterization groups from a perspective of a viewer of the image, the organizing including
sorting the 3D Gaussian nodes in the N-ary LOD tree by their relative position in the image as a first sorted rasterization group, and repeating the sorting with the remainder of the 3D Gaussian nodes in the N-ary tree to form the set of sorted rasterization groups from the perspective of the viewer of the image;
splatting and blending the 3D Gaussian nodes within each sorted rasterization group to create a respective single rendering primitive for each of the sorted rasterization groups to provide a total number of rendering primitives, each rendering primitive in the total number of rendering primitives having multiple 3D Gaussian splats; wherein, the sorting, splatting and blending reduces the total number of rendering primitives used in the rendering; and,
blending the reduced total number of rendering primitives into a framebuffer for the rendering.

In some embodiments, the rendering can include:
obtaining the encoded N-ary LOD tree;
downloading and decoding the first block of the N-ary LOD tree containing the one or more root nodes at LOD_T;
sorting the 3D Gaussian blocks by order of streaming priority, the sorting including prioritizing each 3D Gaussian block by the distance of the 3D Gaussian block from a viewing position;
using a top-down, recursive descent from the one or more root nodes at the LOD_T level for identifying at each point in the recursive descent an LOD_k level having a coarseness that satisfies the condition or set of conditions for the viewing position and desired resolution.

In some embodiments, the rendering can further include organizing the 3D Gaussian nodes into a set of sorted rasterization groups, the organizing including
sorting the 3D Gaussian nodes in the N-ary LOD tree by their relative position in the image as a first sorted rasterization group, and repeating the sorting with the remainder of the 3D Gaussian nodes in the N-ary tree to form the set of sorted rasterization groups from the perspective of the viewer of the image;
splatting and blending the 3D Gaussian nodes within each sorted rasterization group to create a respective single rendering primitive for each of the sorted rasterization groups to provide a total number of rendering primitives, each rendering primitive in the total number of rendering primitives having multiple 3D Gaussian splats; wherein, the sorting, splatting and blending reduces the total number of rendering primitives used in the rendering; and,
blending the reduced total number of rendering primitives into a framebuffer for the rendering.

In some embodiments, the methods include further enhancing a compression performance; wherein,
the pairing further includes prioritizing the pairing in an order of priority of similarity, where the most similar G_a and G_b has the highest priority and is paired first, and the least similar G_a and G_b has the lowest priority and is paired last; and,
the encoding further includes ordering at least a portion of the 3D Gaussian nodes in the N-ary LOD tree within each 3D Gaussian block according to a traversal order of the N-ary LOD tree that reflects the pairing of similar 3D Gaussians first, such that consecutively ordered 3D Gaussian nodes in the N-ary LOD tree are spatially correlated to enhance the compression performance.

And, in some embodiments, the methods further include filtering each 3D Gaussian node in the N-ary LOD tree to remove noise, the filtering including applying a Gaussian blur to one or more 3D Gaussian nodes in the N-ary tree, the filtering performed using the modification module on a non-transitory computer readable medium.

Systems are provided having a processor and a memory configured for each embodiment taught herein. For example, a system taught herein will have all of the components and modules necessary for enabling practice of a respective method taught herein. It should be appreciated that, if one or more components or modules is not included but is known to those of skill as, perhaps, a rather common component or module that can be readily implemented, the system and method can be considered to be enabled to those of ordinary skill, regardless.

Systems are provided having a processor and a memory configured with modules that instruct the processor to perform a respective function.

In some embodiments, a system for creating an LOD tree for an image display is provided. The system can include a processor and a memory. The memory can include
a database that is configured for storing system data;
an indexing module configured with instructions to provide a mapping of a parent/child lineage following a pairing of 3D Gaussians in an LOD tree;
a working set module configured with instructions for (i) holding a query set of 3D Gaussians in a working set of 3D Gaussians for use in the pairing; and (ii) updating the working set of 3D Gaussians, the updating including (i) adding a merged 3D Gaussian to the working set, and (ii) removing a first 3D Gaussian that was paired with a neighboring 3D Gaussian to create the merged 3D Gaussian;
a merging module configured with
   (i) instructions for the pairing, the pairing including merging the first 3D Gaussian with the neighboring 3D Gaussian to create the merged 3D Gaussian;
   (ii) instructions for linking the merged 3D Gaussian
      directly to the respective first 3D Gaussian and directly to the respective neighboring 3D Gaussian from which the merged 3D Gaussian was derived;
      directly to the respective first 3D Gaussian and indirectly to one or more descendants of the respective neighboring 3D Gaussian from which the merged 3D Gaussian was derived;
      indirectly to one or more descendants of the respective first 3D Gaussian and directly to the respective neighboring 3D Gaussian from which the merged 3D Gaussian was derived; or,
   indirectly to one or more descendants of the respective first 3D Gaussian and indirectly to the respective neighboring 3D Gaussian from which the merged 3D Gaussian was derived;
   and
   (iii) instructions for storing the branch in the LOD tree in the database;
      wherein, each linking includes creating a branch in the LOD tree and storing the branch from each linking in the database for building the LOD tree, the linking performed using the indexing module on a non-transitory computer readable medium;
and,
an encoding module configured with instructions for encoding the LOD tree.

In some embodiments, the systems can be further configured for rendering an image display from the LOD tree. As such, the systems can further include
a rendering module configured with instructions for rendering an image from one or more root nodes of the LOD tree to begin developing the image;
a traversing module configured with instructions for traversing the LOD tree, the traversing using a top-down, recursive descent from the one or more root nodes through the parent/child lineage in the LOD tree to select 3D Gaussians that provide a desired resolution; and,
a streaming module configured for managing a streaming of the image for a display.

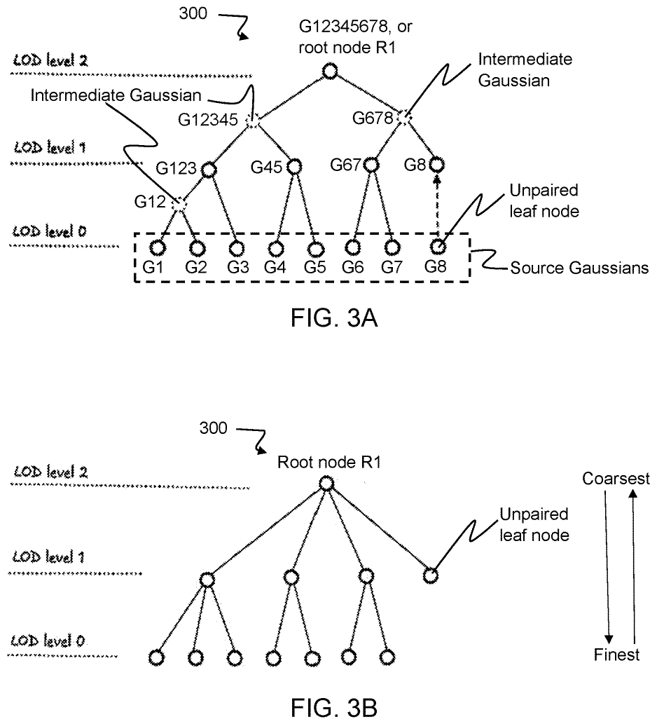

FIG. 2 is a flowchart that illustrates a general method of rendering an image from an LOD tree, according to some embodiments. This method 200 includes rendering 205 the root node(s) to begin developing an image, choosing 210 nodes from the LOD tree, per frame, with continuous selection per image region, and replacing 215 parent Gaussians with child Gaussians from the LOD tree for Gaussians needing refinement. In some embodiments, the set of Gaussians filling a level in an LOD tree can be referred to as a Gaussian node, or node, of the tree.

The rendering 205 can be done to begin the process in which the root node(s) can be a single Gaussian nodes or plurality of Gaussian nodes that meet a criteria. The choosing 210 of Gaussians from the tree can be based on a camera+screen space criteria, for example, and this can be done by continuous selection per region. The choosing 210 is not done using tile-level only, making it an improvement over tile-level techniques used in state-of-the-art methods. The replacing 215 is a method of refining the image, and the refining can provide smooth transitions.

One of skill will appreciate that the method 200 does not require training or retraining Gaussians, the lineage is a “first-class output” and not just a few independent LOD meshes or tiles. Streaming with a continuous level-of-detail is provided by the trees taught herein, as opposed to using a top-down “tiling” approach. The technologies herein can be referred to as a “progressive LOD”, in some embodiments, as the technologies can use a “coarse-first” display that is structurally supported by the lineage in the LOD tree.

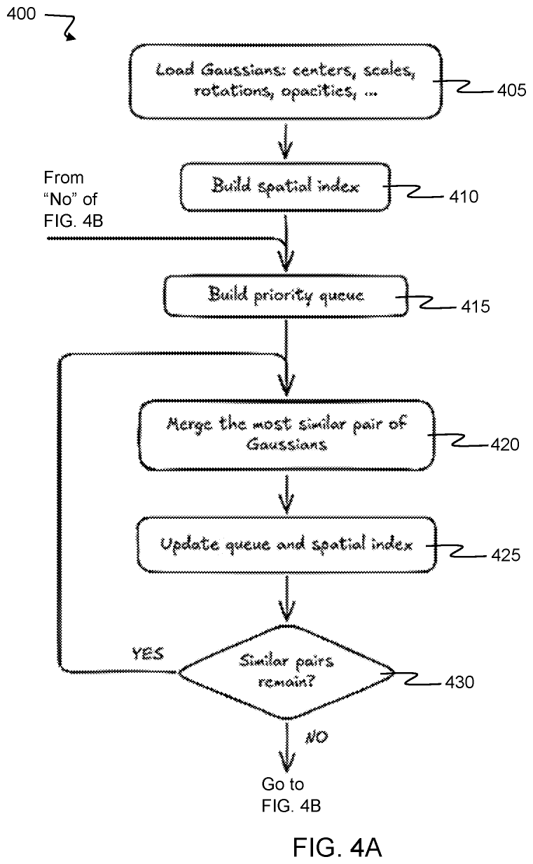

FIGS. 3A and 3B show a simplified construction of an LOD tree and conversion of the LOD tree into an N-ary LOD tree, according to some embodiments. The drawing is highly simplified, of course, because it is using only 8 Gaussians to illustrate the construction of an LOD tree. In contrast, a 3D Gaussian data set can easily have millions of Gaussians in a set of source 3D Gaussians used to build the tree.

In FIG. 3A, the set of source 3D Gaussians are shown in a horizontal line labeled as “LOD level 0”. These Gaussians can also be referred to as “leaf nodes” in the LOD tree. A system taught herein can query a working set of Gaussians for similar Gaussians, and rank the Gaussians in level of similarity. The most similar Gaussians can be paired first to form a merged Gaussian or “parent” Gaussian derived from the pairing of the respective “child” Gaussians. The pairing is followed by an updating of the working set, wherein the parent Gaussian is added to the working set, and the respective child Gaussians from which the parent Gaussian was derived are removed from the working set. The pairing and updating are repeated until the working set no longer contains a pair of Gaussians that are sufficiently similar for LOD level 0. The Gaussians remaining in the working set are assigned to “LOD level 1”.

FIG. 3A also shows the creation of an “intermediate Gaussian” in LOD level 0. Gaussian G12 is a merged Gaussian derived from Gaussian G1 and Gaussian G2. Gaussian G3 did not meet the criteria for pairing until Gaussian 12 was added to the working set and G1 and G2 were removed, and the pairing of Gaussian 12 and Gaussian 3 was, apparently, the last pair of Gaussians in the working set to meet the pairing criteria. As such, after the final pairing, or “merging” of G12 with G3, Gaussians G123, G45, G67, and G8 were assigned to LOD level 1. Likewise, Gaussians G12345 and G678 were intermediate Gaussians that met the pairing criteria, and they were paired to form Gaussian G12345678, or root node, R1. The coarseness of LOD level 0 offers the highest resolution image in the LOD tree. The coarseness increases from LOD level 0 to LOD level 1, and the coarseness increases again from LOD level 1 to LOD level 2. Root node R1 is the coarsest level offering the lowest resolution in the LOD tree.

It should be further noted that, when the set of LOD level 1 Gaussians are assigned to LOD level 1, only those remain in the working set. Likewise, when the set of LOD level 2 Gaussians are assigned to LOD level 2, only those remain in the working set. The number of Gaussians remaining in the working set decrease at each level. However, the entirety of the Gaussians assigned to LOD levels 0, 1, and 2 are eventually linked by lineage (i) from the root node R1 at LOD level 2 to the pair of respective child Gaussians from which it was derived in LOD level 1, (ii) from each parent Gaussian in LOD level 1 to the respective pair of child Gaussians in LOD level 0 from which the respective parent Gaussian was derived.

FIG. 3A also shows the preservation of leaf node G8. Evidently, G8 never met the criteria for a pairing at LOD level 0, and so it was assigned to LOD level 1 by a rule that requires unpaired leaf nodes to continue to be assigned level-by-level through the tree, meaning they may reach an assignment to the root node(s) if they never meet a criteria for a pairing.

FIG. 3B shows a conversion of the LOD tree of FIG. 3A into an N-ary LOD tree by removing the intermediate Gaussians in FIG. 3A. Intermediate Gaussians G12, G12345, and G678 were removed, leaving only the Gaussians assigned to each of LOD levels 0, 1, and 2. The root node R1 at LOD level 2 was the linked to directly the child Gaussians in LOD level 1 from which it was derived, Gaussians G123, G45, G67, and G8. Likewise, each Gaussian in LOD level 1 was linked to each respective child Gaussian in LOD level 0 from which it was derived. The unpaired Gaussian G8 that was assigned from LOD level 0 to LOD level 1 did not have any child Gaussians to link. As shown in FIG. 3B, the tree can be traversed up and down the tree to select a desired level of image resolution from the coarsest level which contains the root node(s) to the finest level which contains the leaf nodes.

As can be seen from FIGS. 3A and 3B, the linking each merged 3D Gaussian can occur
directly to the respective first 3D Gaussian and directly to the respective neighboring 3D Gaussian from which the merged 3D Gaussian was derived;
directly to the respective first 3D Gaussian and indirectly to one or more descendants of the respective neighboring 3D Gaussian from which the merged 3D Gaussian was derived;
indirectly to one or more descendants of the respective first 3D Gaussian and directly to the respective neighboring 3D Gaussian from which the merged 3D Gaussian was derived; or,
indirectly to one or more descendants of the respective first 3D Gaussian and indirectly to the respective neighboring 3D Gaussian from which the merged 3D Gaussian was derived;
wherein, each linking includes creating a branch in the LOD tree and storing the branch from each linking in the database for building the LOD tree.

Links or “branches” are connections made to create a pathway from a parent 3D Gaussian to one or more descendant 3D Gaussians from which the parent 3D Gaussian was derived. A parent 3D Gaussian is a “progeny” of it's “descendant” children from which it was derived. When a pathway is traversed from a progeny or parent 3D Gaussian to its descendant or child 3D Gaussians, the resolution changes from coarser to finer, where the set of source 3D Gaussians provide the finest resolution, and the one or more root nodes provide the coarsest resolution. In some embodiments, a link is direct from a progeny 3D Gaussian to a descendant 3D Gaussian when the progeny 3D Gaussian was directly produced from the descendant 3D Gaussian. In some embodiments, a link is direct from a progeny 3D Gaussian to a descendant 3D Gaussian when the progeny 3D Gaussian was indirectly produced from the descendant 3D Gaussian, where the descendant 3D Gaussian produced an intermediate progeny 3D Gaussian that was removed to create the indirect link.

The following table labels a variety of links shown in FIG. 3B as “direct” or “indirect”, referencing FIG. 3A for child and parent 3D Gaussians linked in FIG. 3B, as examples of direct and indirect links, for some embodiments:

TABLE 1
Examples of “direct” and “indirect” links, for some embodiments.

| Progeny | Descendant | | Direct | Indirect | |
|---|---|---|---|---|---|
| (parent) | (child) | Intermediate | link | link | Comments |
| G12345678 | G123 | G12345 | | X | R1 links to G123 indirectly by |
| R1 | | | | | going through, or removing, |
| | | | | | intermediate G12345 |
| G12345678 | G45 | G12345 | | X | R1 links to G45 indirectly by |
| R1 | | | | | going through, or removing, |
| | | | | | intermediate G12345 |
| G12345678 | G67 | G678 | | X | R1 links to G67 indirectly by |
| R1 | | | | | going through, or removing, |
| | | | | | intermediate G678 |
| G12345678 | G8 | G678 | | X | R1 links to G8 indirectly by |
| R1 | | | | | going through, or removing, |
| | | | | | intermediate G678 |
| G123 | G1 | G12 | | X | G123 links to G1 indirectly by |
| | | | | | going through, or removing, |
| | | | | | intermediate G678 |
| G123 | G2 | G12 | | X | G123 links to G1 indirectly by |
| | | | | | going through, or removing, |
| | | | | | intermediate G678 |
| G123 | G3 | NONE | X | | G123 links to G3 directly |
| | | | | | without going through, or |
| | | | | | removing, an intermediate |
| G45 | G4 | NONE | X | | G45 links to G4 directly without |
| | | | | | going through, or removing, an |
| | | | | | intermediate |
| G45 | G5 | NONE | X | | G45 links to G5 directly without |
| | | | | | going through, or removing, an |
| | | | | | intermediate |
| G67 | G6 | NONE | X | | G67 links to G6 directly without |
| | | | | | going through, or removing, an |
| | | | | | intermediate |
| G67 | G7 | NONE | X | | G67 links to G7 directly without |
| | | | | | going through, or removing, an |
| | | | | | intermediate |
| G8 | N/A | N/A | N/A | N/A | G8 is an unpaired leaf node so |
| | | | | | assigned to LOD level 1 by |
| | | | | | default |

Since FIGS. 3A and 3B are a simple representation used to illustrate a simple teaching, one of skill will appreciate that the pairing of millions of 3D Gaussians to render an image can result in complex levels of intermediates. As such, links can be formed indirectly between a progeny and one of its descendants by going through, or removing, one or more intermediate 3D Gaussians in the formation of an LOD tree. In some embodiments, links can be formed indirectly by going through, or removing, 1, 2, 3, 4, 5, 6, 7, 8, 9, 10, 11, 12, 13, 14, 15, 16, 17, 18, 19, 20 or more intermediate 3D Gaussians. In some embodiments, links can be formed indirectly by going through, or removing, 10, 20, 30, 40, 50, 60, 70, 80, 90, 100, 200, 300, 400, 500, 600, 700, 800, 900, 1000, 2000, 3000, 4000, 5000 or more intermediate 3D Gaussians, or any range or amount therein in increments of 1 intermediate 3D Gaussian. The number of intermediate 3D Gaussians removed in the building of an LOD tree can depend on a particular application for an image, a particular type of image, a particular region within an image, a particular view represented by an image, and the like, in some embodiments. The number of intermediate 3D Gaussians removed in the building of an LOD tree, for example, to form an indirect link between a progeny and a descendant of the progeny can be independently selected for a link to a single 3D Gaussian, links within a group of 3D Gaussians, links within a block of 3D Gaussians, and the like, in some embodiments. Intermediate 3D Gaussians can be removed in “level-by-level” LOD tree building methods, for example, during the merging and creation of progeny to assign each level of the tree, in some embodiments. Intermediate 3D Gaussians can be removed in “free-form” LOD tree building methods, for example, either during the merging and creation of progeny to build the tree, in some embodiments, or after the merging and creation of all progeny, including the progeny that are the root node(s) of the free-form LOD tree, in some embodiments.

It should be appreciated that the linking can be performed using instructions configured in any of the modules that may be present in any of the systems. In some embodiments, the instructions for the linking is configured in an indexing module on a non-transitory computer readable medium. In some embodiments, the instructions for the linking is configured in a merging module on a non-transitory computer readable medium. In some embodiments, the instructions for the linking is configured in a pairing indexing module on a non-transitory computer readable medium. In some embodiments, the instructions for the linking is configured in a linking module on a non-transitory computer readable medium.

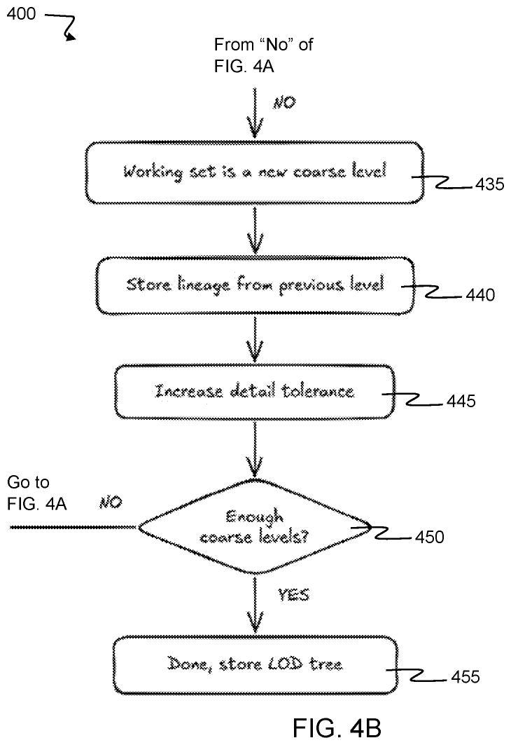

The LOD trees can be configured using any series of steps and criteria that aligns with any of the embodiments provided herein. FIGS. 4A and 4B provide a decision flowchart for a building of an LOD tree, according to some embodiments.

As shown in FIG. 4A of decision flowchart 400, the first step is to load the set of source 3D Gaussians, each Gaussian in the set of source 3D Gaussians indexed and having it's own respective attributes of a 3D Gaussians including, for example, some combination of a center, scales, rotations, opacities, and the like. Additional attributes of 3D Gaussians can be included. The next step 410 is to build a spatial index of 3D Gaussians, and this spatial index can be referred to as a working set. The spatial index can be, for example, an octree that maintains a query set of Gaussians to enhance the efficiency of searching for Gaussian pairs during the building of the LOD tree.

The next step 415 is to build a priority queue of similar 3D Gaussians, the priority queue setting a priority for the order of pairing of sufficiently similar 3D Gaussians in the building of the LOD tree. Most similar Gaussian pairs are merged first, and least similar Gaussian pairs are merged last, but all Gaussians that are paired and merged need to be sufficiently similar at the current level to be entered into the priority queue for prioritizing.

The next step 420 is to merge the most similar pair of 3D Gaussians that are sufficient similar for the pairing. The next step 425 is to update the priority queue and the spatial index as the working set. As Gaussian pairs are merged, merged parent Gaussians are created and added to the working set, and the respective paired child Gaussians are removed from the working set. This means that, as the working set is updated after every pairing, priorities can change as new Gaussian pairings are created. The next step 430 is to determine whether there are any sufficiently similar pairs of Gaussians remain in the working set. If yes, steps 420 and 425 are repeated. If no, we go to FIG. 4B.

If no similar Gaussians remain in the working set, the next step 435 in FIG. 4B is to assign the working set as a new coarse level to repeat the merging. If the set of source Gaussians is LOD level 0, for example, the next new coarse level can be named LOD level 1, which is a coarser level than LOD level 0. After assigning the working set as the new coarse level, LOD level 1, the next step 440 is to store the lineage of each Gaussian in LOD level 1 by recording the parent/child relationship between each parent Gaussian in LOD level 1 and it's respective child Gaussians in LOD level 0. Each Gaussian in the lineage gets a list of children from the previous level from which that Gaussian was derived.

The next step 445 is to increase the “detail tolerance” for the next pairings to increase the coarseness from LOD level 1 to LOD level 2. In some embodiments, the detail tolerance can be referred to as a “radius”. In some embodiments, the detail tolerance can be referred to as a “similarity threshold”. In any event, the detail tolerance represents a minimum similarity measure that must be met at the current level for a sufficient similarity to be present for continuing the pairing. The next step 450 is to determine whether there are enough levels of coarseness in the LOD tree. If not, we return to FIG. 4A and repeat steps, 415, 420, 425, 430, 435, 440, 445, and 450 until there are enough levels of coarseness in the LOD tree.

Once there are enough levels of coarseness in the LOD tree, the LOD tree is stored in step 455. In some embodiments, the nodes of the tree can be ordered breadth-first and the sequence can be cut into blocks, which are compressed for individual streaming.

Systems are provided herein for performing the methods taught herein, and the systems can include a processor and a memory having a variety of instructions set-forth in a variety of modules for instructing the processor in performing the methods.

Systems are provided for building the LOD tree. In some embodiments, the systems can include a module configured for pairing similar Gaussians to produce a merged parent Gaussian. In some embodiments, the systems can include a module configured for modifying the merged parent Gaussian to approximate the child Gaussians from which the merged parent Gaussian was derived. In some embodiments, the systems can include a module configured for indexing each parent Gaussian and each of the child Gaussians from which the respective parent Gaussian was derived. In some embodiments, the systems can include a module configured for linking each parent Gaussian to the child Gaussians from which the respective parent Gaussian was derived for an encoding of the tree. And, in some embodiments, the systems can include a module configured for packaging the LOD tree for a streaming. In some embodiments, the packaging can include a chunking of Gaussians, compression, a metadata layout, or combinations thereof, for the streaming.

One of skill will appreciate that the technologies taught herein provide systems and methods that deliver a persistent representation of an LOD hierarchy. In some embodiments, the persistent representation of the LOD hierarchy can include a set of linked Gaussians that can be tracked from one or more root node Gaussians to a set of source Gaussians, or leaf nodes, the tracking done through a lineage that is a path that takes each root node to the respective leaf nodes from which the respective root node was derived. In some embodiments, the persistent representation of the LOD hierarchy can also include lineage pointers, error metrics, and combinations thereof. One of skill will also appreciate that the technologies taught herein can provide systems and methods that progressively refine images. In some embodiments, the progressively refining includes using streamable chunks of Gaussians to assist in the rendering. In some embodiments, the progressively refining includes using metadata.

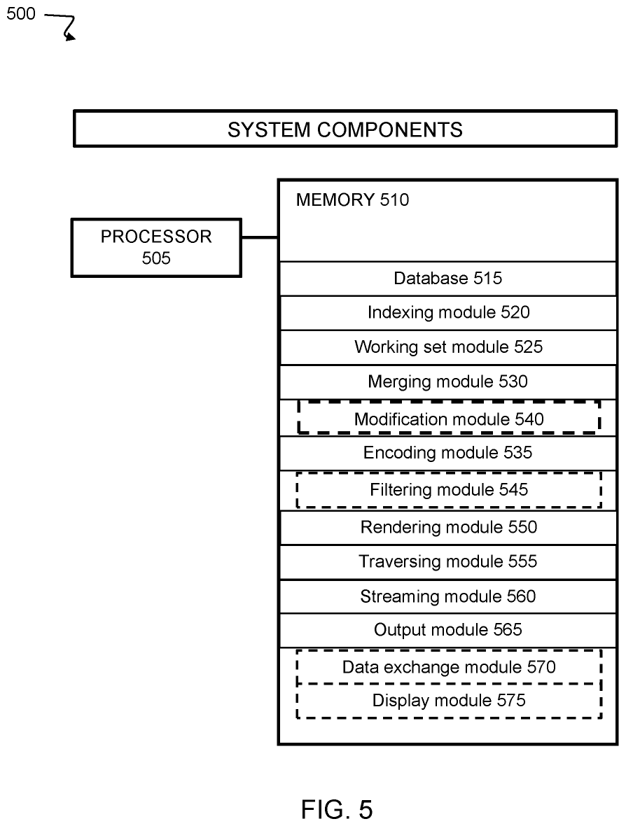

FIG. 5 illustrates a processor-memory diagram to describe components of systems taught herein, according to some embodiments. The system 500 shown contains a processor 505 and a memory 510 (that can include non-volatile memory), wherein the memory 510 can include a database 515 that is configured for storing system data. The modules that are considered optional in some embodiments are shown using dashed lines.

The memory can be configured to include one or more modules, each on a non-transitory computer readable medium, and each configured with a respective set of instructions for the processor to perform a respective function in the system. The memory can include an indexing module 520 configured with instructions to provide a mapping of a parent/child lineage for each of the 3D Gaussians in an LOD tree.

The memory can also include a working set module 525 configured with instructions for holding a query set of 3D Gaussians and, in some embodiments, the working set can be referred to as “the working set_M” and is configured for holding a query set of 3D Gaussians, where M is an integer increasing from 0 to x, M=0 is an initial query set corresponding to the initial set of 3D Gaussians, and M=x is a final query set of 3D Gaussians.

The memory can also include a merging module 530 configured with instructions for pairing a first 3D Gaussian with a neighboring 3D Gaussian to create a merged 3D Gaussian. The pairing can occur in a working set. In some embodiments, the pairing can occur between 3D Gaussians in the working set_M, and starting within the source 3D Gaussians. The pairing can include, for example, assessing the first 3D Gaussian and the neighboring 3D Gaussian for a sufficient similarity for the merging; and, if the first 3D Gaussian and the neighboring 3D Gaussian are sufficiently similar, then creating a respective merged 3D Gaussian by pairing the first 3D Gaussian; and, indexing the respective merged 3D Gaussian for a mapping of the parent/child lineage between the first 3D Gaussian, the neighboring 3D Gaussian and the merged 3D Gaussian.

The 3D Gaussians need to be linked by the parent/child lineage in the LOD tree. The indexing module 520 is further configured with instructions for linking each merged 3D Gaussian to the respective first 3D Gaussian and the respective neighboring 3D Gaussian from which the merged 3D Gaussian was derived, each linking creating a branch in the LOD tree, the linking including storing the branch from each linking in the database.

The memory can also include an encoding module 535 configured with instructions for encoding the LOD tree. In some embodiments, the encoding module is configured with instructions for efficiently encoded for streaming delivery to client devices.

The memory can also include a modification module 535 configured with instructions for modifying each merged 3D Gaussian, the modifying including adjusting one or more attributes in the set of 3D Gaussian attributes of each merged 3D Gaussian to geometrically and visually approximate the respective first 3D Gaussian and the respective neighboring 3D Gaussian merged to form the respective merged 3D Gaussian.

The systems can be configured to remove noise from one or more 3D Gaussians in an LOD tree. The modification module 535 can be further configured with instructions for filtering each, or one or more, 3D Gaussians in the LOD tree to remove noise. In some embodiments, the filtering can include applying a Gaussian blur to one or more 3D Gaussian nodes in the LOD tree. In some embodiments, a filtering module 545 can be added as a separate module configured with instructions for the filtering.

Systems can also be configured for rendering images from the LOD tree. The system of FIG. 5, for example, can have additional modules that support the steps of rendering 205, choosing 210, and replacing 215 described by FIG. 2.

For the rendering 205, in some embodiments, the systems can include a rendering module 550 configured with instructions for rendering an image from the one or more root nodes of the tree to begin developing the image.

For the choosing 210 and the replacing 215, in some embodiments, the systems can include a traversing module 555 configured with instructions for traversing the tree, the traversing using a top-down, recursive descent from the one or more root nodes through the lineage in the tree to select nodes that provide a desired resolution, or coarseness level of the image. The top-down, recursive descent can be referred to as a “tree traversal” or a “traversal” of the tree in the rendering of the image. In some embodiments, the tree traversal can consider screen-space, distance, and the like, to select the nodes that provide the desired resolution from the tree.

In some embodiments, the systems can also include a streaming module 560 configured for managing streaming. The managing can include, for example, requesting child Gaussians or blocks of child Gaussians, “child chunks”, to manage the cache, prioritize, and the like. In some embodiments, the systems can also include a module for integrating the rendering. The integrating can include, for example, drawing select Gaussians, handling smooth parent-to-child refinement transitions, and the like.

In some embodiments, the systems can also include an output module 565 configured with instructions for providing an output of data from the system, which can include an upload to a local drive, a network, the internet, or the cloud, including a local video display or audio output, and the like.

In some embodiments, the system can include a data exchange module 570 configured with instructions for exchanging data from the system with data from another system including an online social network for users of the system. The data exchange module 570 can be configured with instructions to exchange data with any or all forms of external computer readable media.

In some embodiments, the system can include a display module 575 configured with instructions for display of data in the building of an LOD tree or the rendering of an image or images from the LOD tree. The display module 575 can also be a part of the output module 565, in some embodiments.

The system can include input/output devices (not shown) operable to receive and audio data or video data on a non-transitory computer readable medium, such as the data exchange module 560. Examples of input devices are operable to interact with external data formats, voice-recognition software, a hand-held device in communication with the system including, but not limited to, a microphone, and the like, as well as a camera or other video image capture and transmission device. It should be appreciated that the input and output can be an analog or digital audio or video,

The database 520 is operable to store data on each user of the system for access on a non-transitory computer readable storage medium. Any digital data can be stored and accessed, including text files, as well as audio or video files known to one of skill in the art. As such, sound files, text files, image files, and the like can be processed. In some embodiments, the system can access any of a variety of accessible data through a data exchange module, as discussed above.

The system can include input/output devices (not shown) operable to receive and audio data or video data on a non-transitory computer readable medium. All memory components, including modules, is embodied on a non-transitory computer readable medium in the systems taught herein.

The systems and methods taught herein can be implemented on a variety of devices. In some embodiments, the devices can be of any form, whether handheld, desktop, intranet, internet, or otherwise cloud-based. In some embodiments, the device can be a handheld device including, but not limited to, a PDA, a smartphone, an iPAD, a personal computer, and the like, including devices that are not intended for any other substantial use.

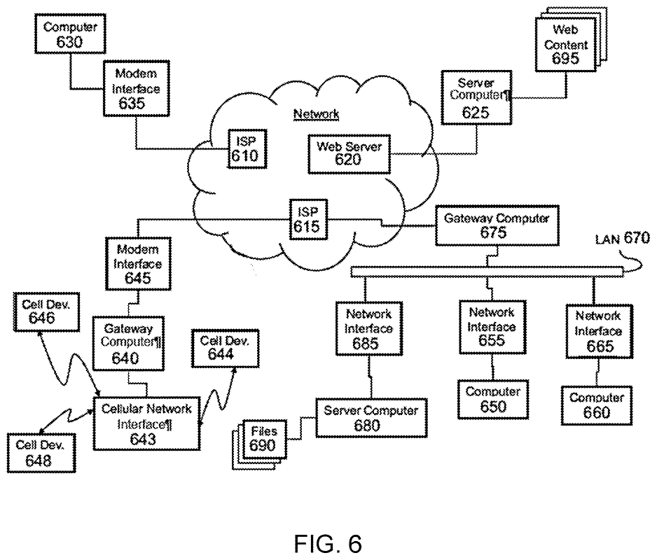

FIG. 6 shows how a network may be used for the systems and methods taught herein, in some embodiments. FIG. 6 shows several computer systems coupled together through a network 605, such as the internet, along with a cellular network and related cellular devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 605 is typically provided by internet service providers (ISP), such as the ISPs 610 and 615. Users on client systems, such as client computer systems 630, 650, and 660 obtain access to the internet through the internet service providers, such as ISPs 610 and 615. Access to the internet allows users of the client computer systems to exchange information, receive and send e-mails, and view documents, such as documents which have been prepared in the HTML format, for example. These documents are often provided by web servers, such as web server 620 which is considered to be “on” the internet. Often these web servers are provided by the ISPs, such as ISP 610, although a computer system can be set up and connected to the internet without that system also being an ISP.

In some embodiments, the system is a web enabled application and can use, for example, Hypertext Transfer Protocol (HTTP) and Hypertext Transfer Protocol over Secure Socket Layer (HTTPS). These protocols provide a rich experience for the end user by utilizing web 2.0 technologies, such as AJAX, Macromedia Flash, etc. In some embodiments, the system is compatible with Internet Browsers, such as Internet Explorer, Mozilla Firefox, Opera, Safari, etc. In some embodiments, the system is compatible with mobile devices having full HTTP/HTTPS support, such as IPHONE, ANDROID, SAMSUNG, POCKETPCs, MICROSOFT SURFACE, video gaming consoles, and the like. Others may include, for example, IPAD and ITOUCH devices. In some embodiments, the system can be accessed using a Wireless Application Protocol (WAP). This protocol will serve the non HTTP enabled mobile devices, such as Cell Phones, BLACKBERRY devices, etc., and provides a simple interface. Due to protocol limitations, the Flash animations are disabled and replaced with Text/Graphic menus. In some embodiments, the system can be accessed using a Simple Object Access Protocol (SOAP) and Extensible Markup Language (XML). By exposing the data via SOAP and XML, the system provides flexibility for third party and customized applications to query and interact with the system's core databases. For example, custom applications could be developed to run natively on APPLE devices, Java or .Net-enabled platforms, etc. One of skill will appreciate that the system is not limited to any of the platforms discussed above and will be amenable to new platforms as they develop.

The web server 620 is typically at least one computer system which operates as a server computer system and is configured to operate with the protocols of the world wide web and is coupled to the internet. Optionally, the web server 620 can be part of an ISP which provides access to the internet for client systems. The web server 620 is shown coupled to the server computer system 625 which itself is coupled to web content 695, which can be considered a form of a media database. While two computer systems 620 and 625 are shown in FIG. 6, the web server system 620 and the server computer system 625 can be one computer system having different software components providing the web server functionality and the server functionality provided by the server computer system 625 which will be described further below.

Cellular network interface 643 provides an interface between a cellular network and corresponding cellular devices 644, 646 and 648 on one side, and network 605 on the other side. Thus cellular devices 644, 646 and 648, which may be personal devices including cellular telephones, two-way pagers, personal digital assistants or other similar devices, may connect with network 605 and exchange information such as email, content, or HTTP-formatted data, for example. Cellular network interface 643 is coupled to computer 640, which communicates with network 605 through modem interface 645. Computer 640 may be a personal computer, server computer or the like, and serves as a gateway. Thus, computer 640 may be similar to client computers 650 and 660 or to gateway computer 675, for example. Software or content may then be uploaded or downloaded through the connection provided by interface 643, computer 640 and modem 645.

Client computer systems 630, 650, and 660 can each, with the appropriate web browsing software, view HTML pages provided by the web server 620. The ISP 610 provides internet connectivity to the client computer system 630 through the modem interface 635 which can be considered part of the client computer system 630. The client computer system can be, for example, a personal computer system, a network computer, a web TV system, or other such computer system.

Similarly, the ISP 615 provides internet connectivity for client systems 650 and 660, although as shown in FIG. 6, the connections are not the same as for more directly connected computer systems. Client computer systems 650 and 660 are part of a LAN coupled through a gateway computer 675. While FIG. 6 shows the interfaces 635 and 645 as generically as a “modem,” each of these interfaces can be an analog modem, isdn modem, cable modem, satellite transmission interface (e.g. “direct PC”), or other interfaces for coupling a computer system to other computer systems.

Client computer systems 650 and 660 are coupled to a LAN 670 through network interfaces 655 and 665, which can be ethernet network or other network interfaces. The LAN 670 is also coupled to a gateway computer system 675 which can provide firewall and other internet related services for the local area network. This gateway computer system 675 is coupled to the ISP 615 to provide internet connectivity to the client computer systems 650 and 660. The gateway computer system 675 can be a conventional server computer system. Also, the web server system 620 can be a conventional server computer system.

Alternatively, a server computer system 680 can be directly coupled to the LAN 670 through a network interface 685 to provide files 690 and other services to the clients 650, 660, without the need to connect to the internet through the gateway system 675.

### EXAMPLES

### Example 1. Merging 3D Gaussians Using Similarity Measures in the Building an N-Ary LOD Tree

This example further teaches a generalized example of how an N-ary LOD tree can be built. A system having a processor and a memory is used, and the memory is configured with modules for performing the steps in the process of merging a set of source 3D Gaussians from a bottom level of the N-ary LOD tree as leaf nodes level-by-level to a top level of the N-ary LOD tree to create “root nodes” that complete the levels.

Each level of the N-ary LOD tree is composed of 3D Gaussian nodes. With the exception of the leaf nodes, each of 3D Gaussian node at each level of the tree is linked to the 3D Gaussian nodes at the next lower level from which the 3D Gaussian node was derived. These links are the branches of the tree.

### Merging 3D Gaussians to Create Levels in the Tree

Starting from the bottom of the tree, the 3D Gaussians are merged iteratively to create the 3D Gaussian nodes of the next level. This can be referred to as a “merging phase” for each level of the tree, the merging result in what can be referred to as “top-level Gaussians”. Each 3D Gaussian node can be assigned a detail level of zero to start the process at each level in some embodiments. During processing, the 3D Gaussian nodes can then be queried for similarities between the 3D Gaussians and, if a similarity is close enough, similar Gaussians can be paired and merged into a new, intermediate Gaussian. It should be appreciated that these intermediate Gaussians can participate in further merging within the same level, forming a binary merging chain, but they can be temporary and not part of the final output. Rather, they are used only as internal merge steps to reach a final set of coarse Gaussians for the current level.

At the end of each level's merging phase, only the top-level Gaussians are retained and assigned the current detail level. These become the coarse Gaussians of the level and are recorded as “nodes” in the LOD hierarchy. Each such node maintains references, and the process of adding these references to the nodes can be referred to as “indexing” in some embodiments. The indexing is used to reference a lineage of the node to the finer Gaussians that contributed to its creation (excluding the intermediate Gaussians). The indexing facilitates a forming of N-ary tree branches. One of skill will appreciate that, in some embodiments these merging and indexing steps are based on actual geometric and semantic structure. The skilled artisan will appreciate that this process is quite different from the simple spatial partitioning that limits the performance of the state-of-the-art.

Not all top-level Gaussians, including the original Gaussians, need to be merged at the finest levels. In some embodiments, the assigned level of such unmerged Gaussians thus keeps increasing, until each unmerged Gaussians is placed at an appropriate level of detail in the tree. One of skill will appreciate this type of assignment of each unmerged 3D Gaussian, as the level of detail of a 3D Gaussian commonly varies in space in 3D Gaussian datasets.

In some embodiments, when merging two Gaussians, usage of intermediate Gaussian parameters can be avoided. Instead, for more precision, Gaussians from the nearest previous finer level (or even more than one level back) are recursively collected and merged in some embodiments.

There are well-known formulas for merging N Gaussians with weights wᵢ, such that

$${\sum }_{i} {w}_{i} = 1 :$$

$$namely ,$$

$$\overline{u} = {\sum }_{i = 1}^{N} {w}_{i} {μ}_{i}$$

$$and$$

$$\overline{\sum } = {\sum }_{i = 1}^{N} {w}_{i} [ {\sum }_{i} + ( {μ}_{i} - \overline{μ} ) {( {μ}_{i} - \overline{μ} )}^{⊤} ]$$

The weights are chosen as
ŵᵢ=αᵢ\sqrt{|Σᵢ|}, where αᵢ is the opacity of Gaussian i. The weights are then normalized:

wᵢ¿=ŵᵢ/Σᵢŵᵢ

Colors and optionally spherical harmonic coefficients (or other additional attributes) can be merged as a simple weighted sum, with the same weights wᵢ. as above.

However, opacities require a different treatment, because 3DGS opacity is, in fact, the opacity of a 2D screen-space splat, not of the 3D Gaussian. If treated as 3D opacity, the merged opacities would be diluted too quickly, resulting in coarse levels that are too transparent. Instead, splatting is simulated in a projection plane determined by the smallest axis of the merged Gaussian, i.e., in a plane going through μ̅, with a normal given by the eigenvector corresponding to the smallest eigenvalue of Σ̅. The N Gaussians being merged are projected to this plane and the total opacity is sampled as if the N Gaussians were splatted on top of each other (in any order). In particular, the opacity at each sample point xⱼ in the plane is calculated as

ō(xⱼ)=1−(1−o₁(xⱼ))(1−o₂(xⱼ) . . . (1−o_{N}(xⱼ))

where oᵢ(xⱼ) is the projected 2D opacity of Gaussian i (i.e., its 3D density times αᵢ, integrated along the projection plane.

### The Similarity Measure and Threshold

The similarity measure can be configured as a geometric interpretation. The geometric interpretation can be related to a minimum feature size that needs to be represented at each level. Likewise, the similarity threshold can be referred to as a “radius” in some embodiments, where the similarity threshold can be initialized to the minimum desired feature size. The idea can be to retain the minimum desired feature size in the output. In some embodiments, the minimum desired feature size can simply be the minimum distance between two pairs of input Gaussians needed at the current level, for example, to keep all detail desired at that level.

In some embodiments, the similarity measure can be configured as a Wasserstein distance, due to its geometric interpretability (also known as the Earth Mover's Distance). The Wasserstein distance is

$${W}_{2} {( {g}_{1} , {g}_{2} )}^{2} = {‖ {μ}_{1} − {μ}_{2} ‖}_{2}^{2} + trace ( {\sum }_{1} + {\sum }_{2} − 2 {( {\sum }_{2}^{\frac{1}{2}} {\sum }_{1} {\sum }_{2}^{\frac{1}{2}} )}^{\frac{1}{2}} )$$

When the covariances Σ₁ and Σ₂ are equal, the Wasserstein distance reduces to the Euclidean distance between Gaussian centers μ₁ and μ₂. This lower bound means we only need to search for viable merging candidates within the level radius.

The Wasserstein distance serves as the base and is augmented with a color difference term defined as the L₂ norm of the difference in color vectors. To keep the relevance of color consistent across scales, the term is multiplied by the current radius, r, and weighted by a constant, w_{c}, which can be 0.2 in some embodiments.

As such, in some embodiments, the final similarity metric can be

similarity(g₁,g₂)=W₂(g₁,g₂)+w_{c}·r·∥color₁−−color₂∥₂

wherein, this combined metric penalizes merging of Gaussians with significantly different colors, and encourages semantically meaningful grouping in coarser levels.

The merging of the 3D Gaussians at each level when the 3D Gaussians are similar enough to meet a similarity threshold and continues until no more 3D Gaussians meet the similarity threshold. The similarity threshold is used to determine whether 3D Gaussians are similar enough to be merged. The similarity threshold can be defined for its “current level” in the N-ary LOD tree to define a coarseness for its current level. As such, it can be appreciated that the similarity threshold can be defined independently for each level of the tree, including increasing the similarity threshold to increase for each consecutive level in the N-ary LOD tree. In some embodiments, the similarity threshold increases at each level in the tree to ensure that the coarseness, the amount of detail provided by the respective level, decreases as the tree is built from the bottom up, level-by-level.

### Example 2: Updating a Working Set, and Considering Order of Priority and Change in Order of Priority, in the Building of the N-ary LOD Tree

As described above, in some embodiments, the 3D Gaussians can be merged in order of priority as each level of the N-ary LOD tree built. The merger of the 3D Gaussians can occur, for example, in a series that progresses from a most similar 3D Gaussian pair to a least similar 3D Gaussian pair. And, as described above, in some embodiments, a “working set” of 3D Gaussians is created and updated to facilitate faster queries of the 3D Gaussians for the merging. The working set can be configured, for example, to (i) hold all Gaussians that have not yet been merged at the current level (ii) add “parent” 3D Gaussians created from respective mergers of “child” 3D Gaussians, and (iii) remove the child 3D Gaussians merged to create their respective parent 3D Gaussians. In some embodiments, the spatial index can be an octree. In some embodiments, the spatial index can be a kD tree.

One of skill should appreciate that the order of priority can change during merging of 3D Gaussians, in some embodiments. A pseudocode is provided below as a high-level, informal description of such an embodiment in which the priority of merging is changed through the creation of a new 3D Gaussian in a merging of 3D Gaussians:

```
Pseudocode
# Initialization
build spatial index (SI) over input Gaussians
level = 1
radius = initial_radius
# Outer loop
while radius < max_radius:
  # Build priority queue:
  for each Gaussian g1 in SI:
  neighbors = find_neighbors_within_radius(SI, g1, radius)
  g2 = neighbor with minimum similarity(g1, g2)
  if similarity(g1, g2) < radius:
    queue.push((g1, g2), priority=similarity(g1, g2)) end
  end
# Inner loop
while queue.top_priority( ) < radius:
  (g1, g2) = queue.pop( )
  if g1 or g2 already merged:
  continue
  end
  g3 = merge(g1, g2)
  SI.remove(g1)
  SI.remove(g2) SI.insert(g3)
  # Update queue:
  for g in [g1,g2]:
    neighbors = find_neighbors_within_radius(SI, g, radius)
    for g4 in neighbors:
      if g was best match for g4:
        find new match for g4, push new record to
        queue end
    end
  end
end
  # Assign current level, apply blur
  for each top-level Gaussian g in SI:
    g.level = level
    if not g.leaf:
    update_blur(g, radius) # see text
    end
  end
  # Prepare for next
  level_radius *= level_ratio
  level += 1
end
```

The pseudocode shows that when a merged Gaussian (g1 or g2 in the pseudocode) is removed from the queue and the spatial index, one or more other Gaussians (g4) may need updating in the priority queue, if g4 had g1 or g2 as its best match. For example, a newly created Gaussian g3 might be a new, most similar Gaussian, in g4's “neighborhood”. New 3D Gaussians created in the merging process can be pushed up the priority queue, while stale records are skipped. The stale records can be removed from the queue, in some embodiments.

### Example 3. Reshaping 3D Gaussians in the LOD N-Ary Tree for Optimal Appearance

The least squares opacity fit often produces α̅ values larger than one, which suggests that a single Gaussian struggles to capture the combined opacity of a set of fine Gaussians. While not intending to be bound by any theory or mechanism of action, it is believed that this is because the standard Gaussian density falls off too quickly. This results in suboptimal appearance of coarse levels of the scene, where the coarse Gaussians appear too sparse and too transparent. A reshaping of the Gaussian kernel of the single Gaussian can be done mathematically.

Since an opacity larger than one cannot be rendered, the technologies herein can employ a special class of generalized Gaussian curves that can be referred to as “fat Gaussians” in some embodiments. These fat Gaussians can still have a maximum of one but provide more density and slower fall-off for coarse-level Gaussians:

f(x)=exp(−|wx|^{p})
where p and w are chosen so that a standard shape for the Gaussian kernel of a 3D Gaussian is obtained for p=2 and w=1, but the shape of the Gaussian kernel can be manipulated to have more area under the curve if the least square fit demands opacity greater than one. The parameters p and w are precalculated for several values of 1≤a≤2 so that the area under the generalized curve is an a-multiple of the area under the standard Gaussian curve.

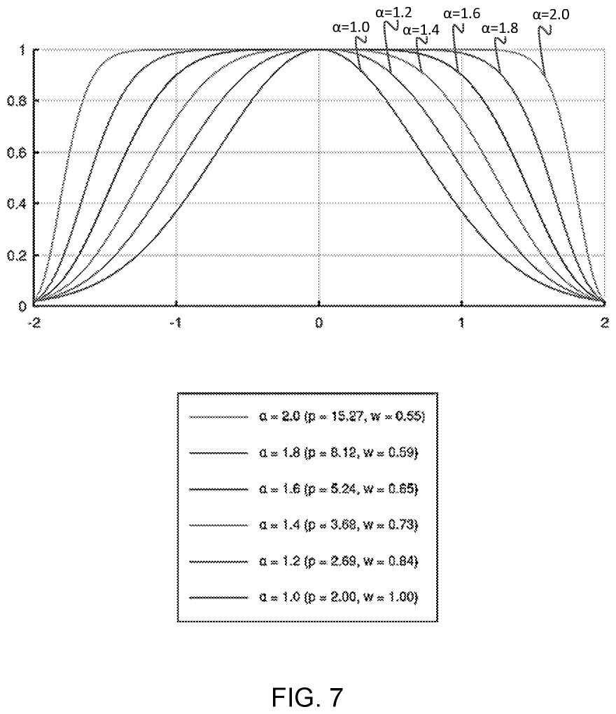

FIG. 7 is a representation of a “fat” Gaussian family of curves, according to some embodiments. Examples of “fat” Gaussian curves for different a values and the associated p and w parameters are shown. The parameters p and w are chosen so that the area under the curve is an a-multiple of the area under the standard Gaussian curve (p=2, w=1), and that the curves meet at predefined cut-off points (e.g., at |x|=2). The curves are precalculated and tabulated for 0≤x≤2 and 1≤α≤2, and stored in a small (e.g., 32×32) look-up texture, to be used by the client-side renderer. Standard Gaussians with α≤1 are multiplied by a and use the basic curve in the table at α=1, while some Gaussians with α>1 use full opacity and one of the generalized curves.

### Example 4. Filtering Out Frequencies from 3D Gaussians in the N-Ary LOD Tree Using Gaussian Blur

Undesirable frequencies can be present in Gaussians and, in some embodiments, when a Gaussian is merged and assigned a coarse level, a Gaussian blur can applied to the Gaussian to filter out frequencies that should not be present at that level.

Applying a Gaussian blur to a 3D Gaussian function is equivalent to convolving one 3D Gaussian with another. Conveniently, the convolution of two Gaussians results in another Gaussian, whose covariance is the sum of the covariances of each of the two Gaussians.

In some embodiments, Gaussian blur can be applied to all Gaussians in a working set, for example, at the end of merging a level. Gaussian blur is not applied to the leaf nodes, which are the original Gaussians placed used to build the tree and placed at the bottom level of the tree as Gaussian nodes of the finest detail in the tree. The final amount of blur can be proportional to the current level's radius, r, times a predefined factor c_{b}. In some embodiments, the predefined factor, c_{b}, can be set a 0.5. Since some non-leaf Gaussians may survive more than one outer loop iteration without getting merged, we subtract from r*c_{b} any blur applied previously. The covariance of the blur kernel added to Σᵢ is thus

Σ_{blur}=diag((r−rₚᵣₑᵥ)·c_{b})²

In addition to preventing aliasing and enabling a progressive streaming experience, filtering the Gaussians also facilitates merging, as the covariances of the filtered Gaussians can eventually converge, making their similarity measure more favorable.

### Example 5. Encoding the N-Ary LOD Tree

The N-ary LOD tree needs to be efficiently encoded for streaming delivery to client devices. Once the N-ary LOD tree is built, whether all the way up to a single root Gaussian that approximates the whole dataset, or to a coarse level that satisfies some condition (sufficiently large radius or low enough Gaussian count), the tree can be efficiently encoded for the streaming delivery to the client devices.

In some embodiments, the tree nodes can be ordered in a linear sequence in a breadth-first manner, meaning a first-in-first-out (FIFO) queue can be used to first assign linear indices to the root level Gaussians, then to their immediate children, then to their children at the next coarse level, etc. It should be appreciated that a “parent” 3D Gaussian at a particular level in the N-ary LOD tree is the product of a merger of “child” 3D Gaussians at that particular level in the tree.

The linear sequence of nodes can then be partitioned into equally sized blocks (typically of 32K or 64K Gaussians), each block encoded independently into a data file that can be served to the rendering client. In some embodiments, the individual blocks may be downloaded by the client in a nonlinear order. Within each block, a number of standard techniques can be employed to efficiently encode coordinates, scales, rotations, colors, child indices and other attributes of the Gaussians. The encoding techniques can include, for example, quantization to a predefined number of bits, delta or predictive coding, statistical (entropy) coding, and the like.

A notable advantage of the way the tree nodes can be built and then ordered linearly is structural and spatial locality. The term “structural locality” can mean that for any non-leaf node, only the index of the first child needs to be encoded, followed by the number of children, to fully define the structure of the tree. The term “spatial locality” can mean that Gaussians with similar linear indices tend to have similar spatial coordinates, similar scales and often correlated colors, with the exception of discontinuities at the end of large tree branches, where the linear index jumps to an unrelated part of the tree.

Experiments show that large spatial discontinuities happen at about 5% of all linear indices. This observation can be used to efficiently encode linear sections of Gaussians where the spatial locality does hold, using predictive and entropy coding methods, to reduce the size of data that needs to be transmitted for each block.

### Example 6. Streaming and Rendering the 3D Gaussians in the N-Ary LOD Tree

Streaming and rendering of 3D Gaussians is how scenes assembled from the 3D Gaussians are displayed. The rendering client, which can be any device, for example, a PC, a phone, a VR headset, a browser, etc., receives a plethora of the 3D Gaussians from the N-ary tree, millions upon millions, to display the scenes.

The rendering client begins by downloading and decoding the first block of the dataset, containing the root nodes of the LOD tree. The client then starts a depth-first recursive descent from the root node (or root nodes), to obtain a list of Gaussians that are suitable for viewing from the current camera position. Since the radius of the root level is known, each finer level radius is also well defined and the recursive descent can be stopped at Gaussians whose level radius is proportional to the pixel size of a projected spatial unit of length at the Gaussian's 3D position. The tree is traversed to collect a set of Gaussians that are sufficient in their level of detail in relation to their distance from the camera. As the camera moves closer to a portion of a scene, finer levels of the LOD tree may be visited to keep the list of Gaussians up to date and sufficiently detailed.

The 3D Gaussians can be separated in Gaussian blocks, which can be referred to simply “blocks”. In some embodiments, due to memory limitations, not all Gaussian blocks from the tree may be present in a client memory when traversing the LOD tree. The recursive descent into a tree branch can be halted prematurely due to lack of data when the children of a tree node are located in a block that the client knows is not available yet. It is straightforward to calculate the block index from the Gaussian index, and so the missing block is marked for download, and the parent Gaussian is displayed temporarily. This is perceived by the user as rendering an out-of-focus portion of the scene, until the block with more detail arrives and the rendering is updated to the desired detail.

Blocks marked for download/streaming are sorted by priority, e.g., by the distance of the nearest missing Gaussian (or its parent) from the camera. A combined streaming priority that includes viewport position (e.g., prioritize viewport center) or some region of interest in the scene is also possible.

Viewing of large scenes that do not fit completely into client memory can be supported. When the client reaches its memory limit, blocks that contain Gaussians that are currently not needed for rendering can be evicted from GPU memory, the CPU memory, or both.

### Rendering Optimizations

One of the challenges in real-time rasterization of splats (mainly Gaussian splats but potentially other types as well) is the high framebuffer bandwidth required to repeatedly alpha-blend rasterization primitives over one another. There is potential parallelization bottlenecks presented for the rasterization hardware by the large number of localized blend operations.

Another bottleneck is the need to sort the primitives by depth or distance from the camera prior to rasterization, especially if the sorting has to be done by the CPU on platforms where compute shaders are not available. This is why we strive for the reduction of the number of primitives that need to be sorted and rasterized, especially in mobile or standalone VR/AR/XR deployments.

The possibility to organize Gaussians into rasterization groups is a benefit of the technologies provided herein. That is, each rasterization group can be rasterized as a single rendering primitive (quadrilateral or triangle fan). Some of the blending can be done within the group in the fragment shader before the splat is actually blended into the framebuffer. While a typical approach uses one quadrilateral to rasterize a single Gaussian, the N-ary LOD trees presented herein makes it possible to (i) rasterize a primitive centered around a parent Gaussian and (ii) splat multiple children Gaussians after the group is sorted by a sorting network in the vertex shader and blended in the fragment shader.

The benefit is a significant reduction in the number of primitives that need to be sorted and rendered. In some embodiments, it is an approximation in terms of the splatting order, but the technique significantly reduces the number of primitives that need to be sorted and rendered. The approximation is enabled by the spatial locality present in the N-ary LOD tree and the similarity-based Gaussian clustering.

### Example 7. Varying Techniques

The technologies provided herein are not limited to a specific method of constructing the level-of-detail (LOD) hierarchy or to a particular configuration of 3D Gaussian attributes. Various alternative embodiments and modifications may be implemented without departing from the core principles of the technologies taught herein.

### Creating a Working Set

The teachings include use of a dynamic octree as the spatial index, which can also be referred to as a working set of Gaussians queried in building the trees with efficient neighborhood queries. However, other spatial data structures can be used, such as k-d trees, bounding volume hierarchies (BVH), or uniform grids. The choice of spatial data structure used should take into account performance trade-offs and hardware considerations.

### Identifying Similar Gaussians:

As described herein, 3D Gaussians can be defined by a set of attributes, and one or more attributes can be used to measure for similarity between Gaussians, the attributes can include, for example, one or more of the following:
position (μ; x,y,z of center/centroid of a Gaussian in space);
covariance (Σ; shape, size, orientation of a Gaussian; can include scaling and rotation);
opacity (α, a scalar value that defines the transparency of a Gaussian);|
color (spherical harmonics represent color as a function of the viewing angle); and,
the attributes can also sometimes include semantic features, temporal components, and/or texture/appearance maps.

In the instant teachings, we discuss using a Wasserstein distance in the similarity measure for determining Gaussian merging candidates. In fact, we also combine the Wasserstein distance with a color difference term. In this discussion, we emphasize that the similarity measure can assessed using different techniques, including substituting or extending any of the techniques taught herein. For example, the Wasserstein-distance can be replaced with another measure, such as other statistical or perceptual distances that can include the Bhattacharyya distance, Kullback-Leibler divergence, or learned similarity metrics from machine learning models. Each of these can be used, in some embodiments, to capture different aspects of spatial or visual coherence.

### Merging Similar Gaussians

The merging operation itself may also be varied. In some embodiments, merged Gaussians may be constructed using weighted averages, maximum-likelihood estimators, or robust statistical methods that mitigate outlier influence. Alternative schemes for opacity merging and fitting may also be used, including the use of alternate families of density functions to better express coarse level Gaussian opacities.

Gaussian kernels can be used in defining Gaussians, as they are mathematical functions that can be described, for example, as defining a 3D Gaussian distribution in the form of a 3D bell-shaped curve. However, the systems and methods taught herein are not limited strictly to the use of Gaussian kernels. Other continuous volumetric kernels may be used in place of Gaussians, such as the Beta kernel or other compactly supported radial basis functions.

Moreover, while the invention is described primarily in the context of static datasets, the same hierarchical approach may be extended to time-varying data, including animated scenes or dynamic environments. For example, the merging and filtering steps can be applied independently at each time frame, or by integrating temporal coherence into the similarity metric.

### Example 8. Clustering is Used, not Tiles, and Blocks can be Used with Compression to Render a Scene

In some embodiments, the technologies herein can be referred to as a “clustering” approach. An LOD tree can be built from the bottom-up by clustering geometrically and visually close Gaussians.

The process is data driven and natural boundaries can arise between branches formed in the LOD tree representing the clusters. The bottom-up process continues from the bottom of the tree starting with a set of source 3D Gaussians to the top of the tree ending with merged 3D Gaussians that form root nodes. The whole dataset can be represented by a single large Gaussian root node, or a set of root nodes that meet a criteria. An N-ary LOD tree is obtained, where each non-leaf Gaussian has 1 to N children, and the leaf nodes are the original set of source 3D Gaussians. The tree can be constructed to have LOD layers or strata, each having a defined resolution that can be configured to increase exponentially with depth, for example. Not all leaves need to be at the same level, however, as the resolution of the input can be non-uniform.

There are no explicit tiles in the LOD tree, and the LOD selection in the viewer is fine-grained, as the tree is traversed exactly to the necessary depth for each currently visible Gaussian.

### Blocks and Compression to Render a Scene

In some embodiments, the tree can be divided into blocks, by cutting the breadth-first ordered nodes into equal-sized sections, for example 64K. Moreover, the blocks can then be compressed and stored as binary files that the viewer can access on demand, starting with block 0. The compression makes use of a high spatial locality of consecutive nodes and compresses individual Gaussians to about 12-13 bytes, where more compression is possible, at least to ~9-10 bytes per Gaussian in some embodiments, and ~6-8 Gaussians in some embodiments. The number of (extra) Gaussians in all the coarse levels of the tree is between 40-50% of the original number of Gaussians (the leaves) in the original set of source 3D Gaussians. The viewer starts by downloading and displaying block 0, so already after downloading ~800 KB, wherein each block might be about 800K with compression, the first rough view of the scene can be shown. More blocks are downloaded on demand, based on the camera position and viewport resolution.

If the initial view has 3M Gaussians, roughly 2*40 MB of data has to be downloaded, where “2” is used as an approximate factor for this explanation due to the block granularity and the presence of coarse Gaussians. Note that all Gaussians do not need to be shown from all blocks.

Once the LOD tree is processed, the blocks can be treated as static CDN assets. The LOD processor (called “gstree”) can be a Linux binary, for example, that uses OpenMP (but no GPU) and takes about 20 minutes to process a 100M Gaussian PLY (polygon file format) on a 10-core laptop, for example.

The splat count can be limited by the available RAM when running gstree (perhaps ~32G to process a 100M dataset). Larger datasets can be processed in chunks, for example, individual chunk LOD trees. The individual chunk LOD trees can later be processed again from a predefined coarse level to create a new “top of the pyramid” LOD tree that covers all the chunks. In some embodiments, this can allow updating some of the chunks and only regenerating the top of the tree.

The coordinates in the PLY may not be transformed in any way, meaning the viewer just uses the same coordinates for the camera movement (with a tweakable up vector). When processing the PLY, a spatial reference system could be defined and included in the metadata, so a future viewer can transform the points to geographic coordinates.

When rendering the scene with the SDK (software development kit), a user-supplied 4×4 matrix can be set, which is applied to the raw coordinates before rendering, so some transforms are already possible.

### Example 9. Scalable and Bandwidth-Efficient for Many Uses

One of skill will appreciate that the systems and methods taught herein offer a scalable and bandwidth-efficient streaming and rendering of complex 3D Gaussian datasets, applicable across a wide range of domains.

One implementation includes integrating the technologies into a web-based service where users can upload large-scale 3D scenes reconstructed using 3D Gaussians. These scenes can be processed using the methods taught herein and served globally through standard web browsers, including on mobile devices. This allows users to interactively explore scenes of arbitrary size, with progressive refinement of visual detail as finer levels of the LOD tree are streamed in.

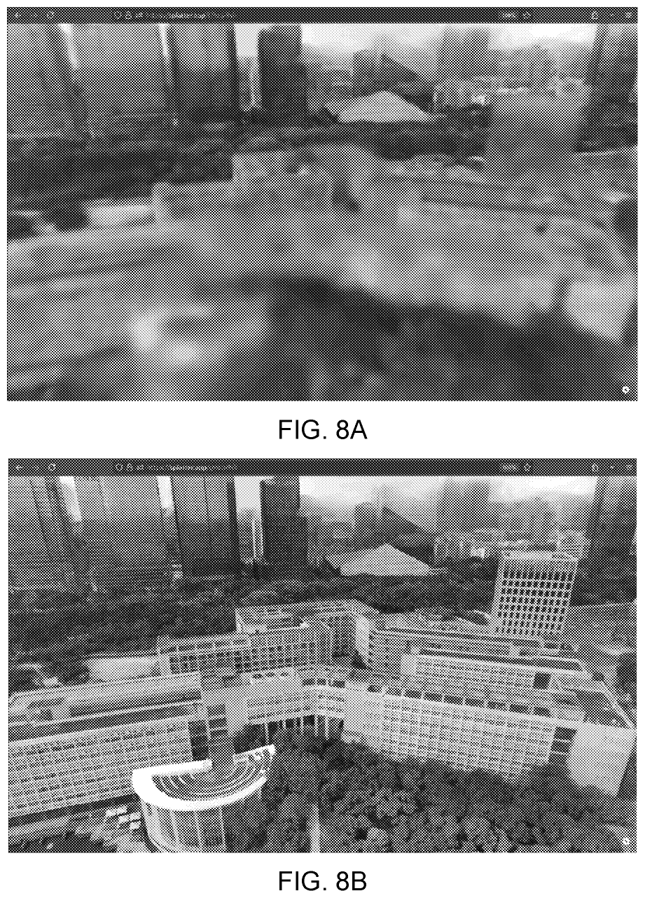

FIGS. 8A and 8B provide screenshots of partial and fully downloaded views of a scene using a web-based service, according to some embodiments. FIG. 8A shows a partially loaded scene, where a blurred or low-detail representation of the content is presented, enabling immediate user interaction while finer details are still streaming in. FIG. 8B shows the scene of FIG. 8A after fully loading, where finer-level Gaussians have been streamed in and rendered. The content is now displayed with full detail matching the current camera position and viewport resolution.

The systems and methods have several potential uses beyond web streaming. For example, multiple industries have several uses where interactive, photorealistic 3D visualization is important, and data bandwidth or rendering performance is constrained. Examples of such domains include the following uses, each representing a method of use taught herein:
Visual Effects (VFX): Efficient preview and manipulation of large 3D scans or set captures, reducing time to first frame and enabling remote collaboration. The LOD structure also sup-ports direct rendering to LED volumes and virtual production stages, where data throughput and latency are critical constraints.
Industrial Spatial Intelligence: Interactive inspection and annotation of spatial datasets such as factory scans or construction sites, accessible from lightweight client devices.
Virtual and Augmented Reality (VR/XR): Real-time rendering of detailed environments on resource-constrained headsets, with level-of-detail adapting to user focus and movement.
Architecture, Engineering, and Construction (AEC): Streaming of building-scale reconstructions for review, client presentation, and tracking of construction progress over time.
Real Estate and Cultural Heritage: Public or private sharing of spatial reconstructions of properties, landmarks, museums, or historical sites. The progressive streaming capability enables smooth virtual tours, where users can quickly explore entire environments and experience higher detail as the view stabilizes or zooms in.

In all such applications, the systems and methods provide a general-purpose solution for bandwidth-sensitive 3D rendering by organizing Gaussian datasets into a compact N-ary LOD tree suitable for streaming, storage, and real-time rendering.

1. A method of building a level-of-detail (LOD) tree of three-dimensional (3D) Gaussians, the LOD tree including a source set of 3D Gaussians and a set of merged 3D Gaussians derived from the source set of 3D Gaussians during the building, the method comprising:
obtaining the source set of 3D Gaussians; and,
building the LOD tree, the building including
storing the 3D Gaussians in a database, each of the 3D Gaussians including a set of attributes, the storing including
indexing each 3D Gaussian in the source set of 3D Gaussians, and each 3D Gaussian in the set of merged 3D Gaussians derived from the source set of 3D Gaussians during the building, the indexing configured to provide a mapping of a parent/child lineage for each of the 3D Gaussians in the LOD tree, the indexing performed using an indexing module on a non-transitory computer readable medium;
creating a working set_M, the working set_M configured for holding a query set of 3D Gaussians, where M is an integer increasing from 0 to x, M=0 is an initial query set corresponding to the initial set of 3D Gaussians, and M=x is a final query set of 3D Gaussians, the creating performed using a working set module on a non-transitory computer readable medium;
pairing a first 3D Gaussian with a neighboring 3D Gaussian to create a merged 3D Gaussian in the set of merged 3D Gaussians, the pairing occurring between 3D Gaussians in the working set_M, and starting within the source set of 3D Gaussians, the pairing including
assessing the first 3D Gaussian and the neighboring 3D Gaussian for a sufficient similarity for the merging; and, if the first 3D Gaussian and the neighboring 3D Gaussian are sufficiently similar, then
creating a respective merged 3D Gaussian by pairing the first 3D Gaussian; and,
indexing the respective merged 3D Gaussian for a mapping of the parent/child lineage between the first 3D Gaussian, the neighboring 3D Gaussian and the merged 3D Gaussian,
the pairing performed using the merging module on a non-transitory computer readable medium;
wherein, the pairing includes repeating the pairing until there are no remaining 3D Gaussians that are sufficiently similar for a further repeating of the pairing;
updating the working set_M, the updating including (i) adding each merged 3D Gaussian to the working set_M, and (ii) removing the paired 3D Gaussians used to create the merged 3D Gaussian from the working set_M, each updating increasing the working set_M from M=0 to M=x, the updating performed using the working set module on a non-transitory computer readable medium;
linking each merged 3D Gaussian
directly to the respective first 3D Gaussian and directly to the respective neighboring 3D Gaussian from which the merged 3D Gaussian was derived;
directly to the respective first 3D Gaussian and indirectly to one or more descendants of the respective neighboring 3D Gaussian from which the merged 3D Gaussian was derived;
indirectly to one or more descendants of the respective first 3D Gaussian and directly to the respective neighboring 3D Gaussian from which the merged 3D Gaussian was derived; or,
indirectly to one or more descendants of the respective first 3D Gaussian and indirectly to the respective neighboring 3D Gaussian from which the merged 3D Gaussian was derived;
wherein, each linking includes creating a branch in the LOD tree and storing the branch from each linking in the database for building the LOD tree, the linking performed using the indexing module on a non-transitory computer readable medium;
and,
encoding the LOD tree using an encoding module on a non-transitory computer readable medium;
wherein,
the building of the LOD tree does not require a training, or a retraining, of the source 3D Gaussian data set of 3D Gaussians.

2. The method of claim 1, further including modifying each merged 3D Gaussian, the modifying including adjusting one or more attributes in the set of 3D Gaussian attributes of each merged 3D Gaussian to geometrically and visually approximate the respective first 3D Gaussian and the respective neighboring 3D Gaussian merged to form the respective merged 3D Gaussian, the modifying performed using a modification module on a non-transitory computer readable medium.

3. A method of building an N-ary level-of-detail (LOD) tree of three-dimensional (3D) Gaussian nodes from a source 3D Gaussian data set, the N-ary LOD tree used for rendering an image at each of a series of levels from a bottom of the N-ary LOD tree used for rendering the image with a finest detail to a top of the N-ary LOD tree used for rendering the image with a coarsest level of detail, each level of the N-ary LOD tree from the bottom of the tree to the top of the tree configured for an increasing in coarseness for the rendering of the image, the N-ary LOD tree providing a bottom-up LOD hierarchy for rendering the image with a desired level of coarseness, the method comprising:
building the N-ary LOD tree as a series of LOD_k levels from k=0 to k=T, the series of LOD_k levels having a bottom level of 3D Gaussian nodes, LOD_0, with a finest resolution, and a top level of 3D Gaussian nodes, LOD_T, with a coarsest resolution, the top level, LOD_T, composed of one or more root nodes, R_g, the building including
storing 3D Gaussians in a database, the storing including
indexing each of the 3D Gaussians, G_g, during the building, the indexing proceeding in the building of the N-ary LOD tree in order from the LOD_0 level to the LOD_T level, each of the 3D Gaussians including a set of 3D Gaussian attributes including a center, a covariance, a color, and an opacity, the indexing providing mapping of a parent/child lineage of each Gaussian node from k=0 to k=T in the N-ary LOD tree, the indexing performed using an indexing module on a non-transitory computer readable medium;
creating a working set_M, the working set_M configured for holding a query set of 3D Gaussians, 3D Gaussian nodes, and combinations thereof, at a current LOD_k level, where M is an integer increasing from 0 to x, M=0 is an initial query set corresponding to the initial finest set of 3D Gaussian nodes at LOD_0, and M=x is a final query set used to create the one or more root nodes, R_g at the LOD_T level, the creating performed using a working set module on a non-transitory computer readable medium;
pairing at the current LOD_k level a first 3D Gaussian, G_a, with a neighboring 3D Gaussian, G_b, the pairing occurring between 3D Gaussians in the working set_M, and starting with the bottom level of 3D Gaussian nodes, LOD_0, and continuing level-by-level through LOD_T, the pairing performed using a merging module on a non-transitory computer readable medium, and the pairing including
querying the working set_M;
assessing G_a and G_b, for a compatibility;
determining whether G_a and G_b satisfy a similarity threshold_k for the current LOD_k level; and, if G_a and G_b are both compatible and meet the similarity threshold_k, then
creating a respective merged 3D Gaussian, G_ab; and,
indexing the respective merged 3D Gaussian, G_ab, as the respective merged 3D Gaussian, G_g, for the mapping of the parent/child lineage between G_a, G_b, and G_ab;
wherein, the pairing at the current LOD_k level includes repeating the pairing until there are no remaining 3D Gaussian pairs in the working set_M satisfying the similarity threshold_k for the current LOD_k level;
updating the working set_M at the current LOD_k level, the updating including (i) adding each merged 3D Gaussian, G_ab, created at the current LOD_k level to the working set_M, and (ii) removing the paired 3D Gaussians, G_a and G_b, used to create the merged 3D Gaussian, G_ab, from the working set_M, the updating performed using the working set module on a non-transitory computer readable medium;
modifying each merged 3D Gaussian, G_ab, the modifying including adjusting one or more attributes in the set of 3D Gaussian attributes of each merged 3D Gaussian, G_ab, to geometrically and visually approximate the 3D Gaussians G_a and G_b, that were paired to form the merged 3D Gaussian, G_ab, the modifying performed using a modification module on a non-transitory computer readable medium;
assigning the 3D Gaussians remaining in the working set_M after completion of the pairing and the modifying at the current LOD_k level as a set of 3D Gaussian nodes, G_(k+1)g, at a next coarser LOD_k+1 level, the assigning performed using the working set module on a non-transitory computer readable medium;
linking each 3D Gaussian node in the set of 3D Gaussian nodes, G_(k+1)g, at the LOD_k+1 level directly to one or more 3D Gaussian nodes at the next finer LOD_k level from which the 3D Gaussian node in the set of 3D Gaussian nodes, G_(k+1)g, originated, each linking creating a branch in the N-ary LOD tree for storage in the database, the linking performed using the indexing module on a non-transitory computer readable medium;
increasing the similarity threshold_k to a similarity threshold_k+1 for the LOD_k+1 level, resulting in the increasing in coarseness from the LOD_k level to the LOD_k+1 level for the rendering of the image, the increasing performed using using the merging module on a non-transitory computer readable medium;
repeating (i) the pairing at the current LOD_k level, (ii) the updating of the working set_M at the current LOD_k level, (iii) the modifying of each merged 3D Gaussian, (iv) the assigning of the 3D Gaussians remaining in the working set_M as the set of 3D Gaussian nodes, G_(k+1)g, at the next coarser LOD_k+1 level, (v) the linking of the set of 3D Gaussian nodes, G_(k+1)g, at the LOD_k+1 level directly to the one or more 3D Gaussian nodes at the next finer LOD_k level from which the set of 3D Gaussian nodes, G_(k+1)g, originated, and (v) the increasing of the similarity threshold_k to the similarity threshold_k+1, the repeating performed in series starting at k=0 and progressing level-by-level until the one or more root nodes, R_g, are formed at LOD_T;
and,
encoding the N-ary LOD tree using an encoding module on a non-transitory computer readable medium;
wherein,
the building of the N-ary LOD tree does not require a training, or a retraining, of the source 3D Gaussian data set; and,
the LOD_T level is a coarseness level of the one or more root nodes that satisfy one or more conditions that include a minimum 3D Gaussian count, a maximum 3D Gaussian count, a similarity threshold_T, or a combination thereof.

4. The method of claim 3, wherein the similarity threshold_k is a minimum required similarity between the first 3D Gaussian, G_a, and the neighboring 3D Gaussian, G_b, for the creating of the respective merged 3D Gaussian, G_ab at the LOD_k level, the similarity threshold_k based on a similarity measure that is a scalar number representing a generalized distance calculation that includes
(i) the position of the center or centroid of the first 3D Gaussian, G_a;
(ii) the position of the respective center or centroid of the neighboring 3D Gaussian, G_b, at the LOD_k level;
(iii) the covariance of the first 3D Gaussian node, G_a, at the LOD_k level;
(iv) the covariance of the neighboring 3D Gaussian node, G_b, at the LOD_k level; and,
(v) combinations thereof.

5. The method of claim 3, wherein the working set_M is a spatial index.

6. The method of claim 3, wherein the working set_M is an octree or a kD tree.

7. The method of claim 3, further including
filtering each 3D Gaussian node in the N-ary LOD tree to remove noise, the filtering including applying a Gaussian blur to one or more 3D Gaussian nodes in the N-ary tree, the filtering performed using the modification module on a non-transitory computer readable medium.

8. The method of claim 4, wherein the similarity measure further includes a semantic measure of each 3D Gaussian, the semantic measure including color, opacity, or a combination thereof.

9. The method of claim 3, wherein the adjusting in the modifying of each merged Gaussian, G_ab, further includes
determining a respective target opacity for each merged Gaussian, G_ab, the respective target opacity representing
the opacities of the 3D Gaussians G_a and G_b, that were paired to form the merged Gaussian, G_ab;
the opacities of the one or more 3D Gaussian nodes at the next finer LOD_k level from which the merged Gaussian node, G_ab, originated;
or, a combination thereof;
and,
reshaping each merged 3D Gaussian, G_ab, to emulate the respective target opacity for each merged 3D Gaussian, G_ab.

10. The method of claim 9, wherein the reshaping includes manipulating a mathematical function used to define the shape of a Gaussian kernel for the respective merged 3D Gaussian, G_ab.

11. The method of claim 3, wherein
the similarity threshold_k is a user-specified constant selected to preserve a desired level of detail at the LOD_k level;
wherein,
similarity threshold_k=(similarity threshold_0)*power (coarsening factor, N)
where,
N ranges from 0 to T; and,
the coarsening factor ranges from 1.1 to 2.9.

12. The method of claim 11, wherein the coarsening factor ranges from 1.8 to 2.3.

13. The method of claim 3, wherein the encoding further includes
partitioning the 3D Gaussian nodes of the N-ary tree into a set of 3D Gaussian blocks, each block in the set of 3D Gaussian blocks encoded into (i) a data file or (ii) a data file section for a streaming of the 3D Gaussian data, a rendering of the 3D Gaussian data to create an image for display, or a combination thereof;
wherein, each block in the set of 3D Gaussian blocks is encoded into the data file using the one or more attributes.

14. The method of claim 13 further enhancing a compression performance; wherein,
the pairing further includes
prioritizing the pairing in an order of priority of similarity, where the most similar G_a and G_b has the highest priority and is paired first, and the least similar G_a and G_b has the lowest priority and is paired last;
and, the encoding further includes
ordering at least a portion of the 3D Gaussian nodes in the N-ary LOD tree within each 3D Gaussian block according to a traversal order of the N-ary LOD tree that reflects the pairing of similar 3D Gaussians first, such that consecutively ordered 3D Gaussian nodes in the N-ary LOD tree are spatially correlated to enhance the compression performance.

15. The method of claim 14, wherein the encoding further comprises
encoding the one or more attributes of the consecutively ordered 3D Gaussian nodes using predictive coding, delta coding, entropy coding, or a combination thereof, based on the spatial correlation of the consecutively ordered 3D Gaussian nodes.

16. A method of rendering the 3D Gaussian nodes in the N-ary LOD tree of claim 3 into the image for display, the method further including
using a top-down, recursive descent from the one or more root nodes at the LOD_T level for identifying at each point in the recursive descent an LOD_k level having a coarseness that satisfies a condition or set of conditions for a viewing position and desired resolution.

17. The method of rendering of claim 16, further comprising organizing the 3D Gaussian nodes in the N-ary LOD tree into a set of sorted rasterization groups from a perspective of a viewer of the image, the organizing including
sorting the 3D Gaussian nodes in the N-ary LOD tree by relative position in the image as a first sorted rasterization group, and repeating the sorting with a remainder of the 3D Gaussian nodes in the N-ary tree to form the set of sorted rasterization groups from the perspective of the viewer of the image;
splatting and blending the 3D Gaussian nodes within each sorted rasterization group to create a respective single rendering primitive for each of the sorted rasterization groups to provide a total number of rendering primitives, each rendering primitive in the total number of rendering primitives having multiple 3D Gaussian splats; wherein, the sorting, splatting and blending reduces the total number of rendering primitives used in the rendering; and,
blending the reduced total number of rendering primitives into a framebuffer for the rendering.

18. A method of rendering the 3D Gaussian nodes in the N-ary LOD tree of claim 13 into the image for display, the method comprising:
obtaining the encoded N-ary LOD tree of claim 13;
downloading and decoding the first block of the N-ary LOD tree containing the one or more root nodes at LOD_T;
sorting the 3D Gaussian blocks by order of streaming priority, the sorting including prioritizing each 3D Gaussian block by a distance of the 3D Gaussian block from a viewing position; and,
using a top-down, recursive descent from the one or more root nodes at the LOD_T level for identifying at each point in the recursive descent an LOD_k level having a coarseness that satisfies a condition or set of conditions for the viewing position and desired resolution.

19. The method of rendering of claim 18, further comprising organizing the 3D Gaussian nodes into a set of sorted rasterization groups, the organizing including
sorting the 3D Gaussian nodes in the N-ary LOD tree by relative position in the image as a first sorted rasterization group, and repeating the sorting with a remainder of the 3D Gaussian nodes in the N-ary tree to form the set of sorted rasterization groups from a perspective of a viewer of the image;
splatting and blending the 3D Gaussian nodes within each sorted rasterization group to create a respective single rendering primitive for each of the sorted rasterization groups to provide a total number of rendering primitives, each rendering primitive in the total number of rendering primitives having multiple 3D Gaussian splats; wherein, the sorting, splatting and blending reduces the total number of rendering primitives used in the rendering; and,
blending the reduced total number of rendering primitives into a framebuffer for the rendering.

20. A system for creating a level-of-detail (LOD) tree for an image display, the system comprising
a processor; and,
a memory, the memory including
a database that is configured for storing system data;
an indexing module configured with instructions to provide a mapping of a parent/child lineage following a pairing of three-dimensional (3D) Gaussians in the LOD tree;
a working set module configured with instructions for (i) holding a query set of 3D Gaussians in a working set of 3D Gaussians for use in the pairing; and (ii) updating the working set of 3D Gaussians, the updating including (i) adding a merged 3D Gaussian to the working set, and (ii) removing a first 3D Gaussian that was paired with a neighboring 3D Gaussian to create the merged 3D Gaussian;
a merging module configured with
(i) instructions for the pairing, the pairing including merging the first 3D Gaussian with the neighboring 3D Gaussian to create the merged 3D Gaussian;
(ii) instructions for linking the merged 3D Gaussian
directly to the respective first 3D Gaussian and directly to the respective neighboring 3D Gaussian from which the merged 3D Gaussian was derived;
directly to the respective first 3D Gaussian and indirectly to one or more descendants of the respective neighboring 3D Gaussian from which the merged 3D Gaussian was derived;
indirectly to one or more descendants of the respective first 3D Gaussian and directly to the respective neighboring 3D Gaussian from which the merged 3D Gaussian was derived; or,
indirectly to one or more descendants of the respective first 3D Gaussian and indirectly to the respective neighboring 3D Gaussian from which the merged 3D Gaussian was derived;
and
(iii) instructions for storing a branch in the LOD tree in the database;
wherein, each linking includes creating the branch in the LOD tree and storing the branch from each linking in the database for building the LOD tree, the linking performed using the indexing module on a non-transitory computer readable medium;
and,
an encoding module configured with instructions for encoding the LOD tree.

21. The system of claim 20 further configured for rendering an image display from the LOD tree, the system further comprising:
a rendering module configured with instructions for rendering an image from one or more root nodes of the LOD tree to begin developing the image; and,
a traversing module configured with instructions for traversing the LOD tree, the traversing using a top-down, recursive descent from the one or more root nodes through the parent/child lineage in the LOD tree to select 3D Gaussians that provide a desired resolution; and,
a streaming module configured for managing a streaming of the image for a display.
